(19) United States
(12) Patent Application Publication
(10) Pub. No.: US 2024/0397315 A1
(43) Pub. Date: Nov. 28, 2024

(54) WORKER NODE CLUSTER MANAGEMENT

(71) Applicant: Telefonaktiebolaget LM Ericsson (publ), Stockholm (SE)

(72) Inventors: Michael OGBUACHI, Budapest (HU); Benedek KOVÁCS, Budapest (HU); Péter SUSKOVICS, Budapest (HU); Anna REALE, Budapest (HU)

(21) Appl. No.: 18/694,244

(22) PCT Filed: Sep. 22, 2021
(86) PCT No.: PCT/EP2021/076091

§ 371 Date: Mar. 21, 2024

(51) Int. Cl. H04W 12/06; H04W 12/043; H04W 48/02; H04W 60/04

(52) U.S. Cl. CPC H04W 12/06; H04W 12/043; H04W 48/02; H04W 60/04

(57) ABSTRACT

There is provided a method for managing a cluster of worker nodes that are controllable by a master node. The method is performed by an entity. A wireless device is automatically allowed to join the cluster as a worker node if the wireless device is authorised to join the cluster. The wireless device is authorised to join the cluster if the wireless device is registered to an owner of the master node and/or cluster of worker nodes. The worker nodes are responsible for providing a computational resource in a network.

### TECHNICAL FIELD

The disclosure relates to a method for managing a cluster of network nodes and an entity configured to operate in accordance with this method. The disclosure also relates to a method for controlling the operation of a wireless device and a wireless device configured to operate in accordance with this method.

### BACKGROUND

Many existing techniques for managing a cluster of worker nodes have limitations as they are mostly restricted, and strongly tailored, to a particular situation. For instance, existing clusters of worker nodes, such as those used for the Internet of Things (IoT), computing, and robotics (e.g. robot swarms for logistics, such as warehouse robots), are meant to perform a certain kind of task. As such, in these instances, it is generally the case that the worker nodes of the cluster can only fulfil the specific task for which they have been designed according to their normal operation, which makes the cluster inflexible. Moreover, as the worker nodes of a cluster in the instances mentioned are usually busy carrying out tasks for which they have been specifically designed, the worker nodes of a cluster are resource constrained in that they have limited available processing power and/or memory. Typical clusters of worker nodes are also inflexible due to their fixed arrangement. For example, clusters of worker nodes are commonly designed for cloud systems that are usually composed of worker nodes rigidly connected in server racks. The worker nodes also need to be manually configured in order to cooperate with each other.

In practice, it is sometimes necessary for a cluster infrastructure to be scaled up or down. However, in view of the inflexibility and resource constraints of existing cluster infrastructures, this can be difficult and generally requires manual intervention. For example, it is possible to create clusters and deploy on them an arbitrary number of software units (which are referred to as pods in the case of Kubernetes clusters), which encapsulate one or more containers. It is also possible to scale up and down the number of these software units, based on certain service requirements. Strategies such as these are typically governed by a single cluster, or by an administration software that manages multiple individual clusters. However, the operations necessary for a cluster to itself be scaled up or down are usually carried out manually. Typically, the scaling down of a cluster involves removing currently running software units and creating new software units on remaining devices. The removal and creation of software units is usually performed via a master node that is responsible for controlling the worker nodes. This process is commonly referred to as a “clean up”. It is only when this “clean up” is completed that a worker node can be officially removed from a cluster. The worker node can then be administrated and authenticated to be able to join a new cluster as a worker node but this administration and authentication is currently a manual process.

Another issue associated with current practices for scaling a cluster infrastructure is that a single cluster can have its own internet protocol (IP) address settings and specific IP policies, and each worker node (especially worker nodes that are user equipments, UEs) must adhere to these settings and policies. Also, if a worker node is to be moved to a different cluster, different IP settings may be required. In view of this, worker nodes do not typically move between clusters in the existing techniques.

There are also certain limitations when it comes to the use of a cluster of worker nodes in a networking environment in mobile networks. In particular, worker nodes (e.g. UEs) in a cellular network cannot normally ping each other and thus network virtualisation layers often need to be used in such cases, which increases the complexity of the existing cluster infrastructures. Furthermore, some existing types of cluster may not support certain IP versions (e.g. IP version 6, IPv6) for some worker nodes. For example, while Kubernetes (K8s) clusters support IPv6 for applications, they only partially support IPv6 for devices. Moreover, typical mobile networks also do not support IPv6 in all cases for UEs. Instead, in most use cases, network access translation (NAT) is used, which again adds to the complexity of existing personal and mobile cluster infrastructures. There are also challenges associated with the fact that the IP address of the master node and worker nodes may change, e.g. due to a request from the mobile network.

### SUMMARY

It is an object of the disclosure to obviate or eliminate at least some of the above-described disadvantages associated with existing techniques.

As described earlier, existing cluster infrastructures can be complex, inflexible, and resource constrained. This can make it difficult to scale the existing cluster infrastructure and such scaling generally requires manual intervention, which can be detrimental to the reliability and security of the cluster infrastructure. It is therefore an object to provide a cluster management technique that reduces complexity, provides greater flexibility, and that is less resource constrained.

In this respect, it is beneficial to consider devices that are operationally flexible and that are able to fulfil some useful computational tasks that may fall outside of the normal operation of the device but that are nevertheless useful in a cluster setting. It has been realised that wireless devices can provide this flexibility and additional resource in a cluster setting. Whereas existing cluster infrastructures comprise worker nodes that do not typically move between clusters, wireless devices can move between clusters to provide additional computational resource.

It is thus useful to consider implementing wireless devices in a cluster infrastructure to obviate or eliminate at least some of the disadvantages associated with the existing techniques described earlier. Advantageously, modern wireless devices are similar to standard computers (especially if compared to the examples of typical cluster devices mentioned above), and often offer enough computational power to fulfil significant computational tasks. Modern wireless devices can also be based on similar system architectures to standard computers and thus an architectural uniformity sometimes exists between modern wireless devices and standard computers. This can enable the workload capabilities (e.g. workload distribution and/or offloading capabilities) that are envisioned with next generation (e.g. fifth generation, 5G) networks to be realised.

However, the potential high mobility of some wireless devices can be problematic, since the wireless devices may frequently move between different regions that may define different clusters of worker nodes and, each time a wireless device moves to a different cluster, a decision needs to be taken as to whether or not to allow the wireless devices to join the cluster. During manual configuration, identifying which wireless devices are allowed to join a cluster is not an issue, since an administrator can be made aware of the wireless devices and the identity verification of the wireless devices can be handled by configuring them correctly. Nevertheless, although the decision on whether or not to allow a wireless device to join a cluster can be achieved by relying on some manual user interaction, this is far from ideal, at least from a scalability, security, and reliability point of view, and thus manual user interaction needs to be avoided.

Ideally, the decision on whether or not to allow a wireless devices to join a cluster is to be automated. However, then the owner of the cluster needs assurance that only authorised wireless devices can join their clusters. This is not straightforward because any communication between the respective master node of the cluster and the wireless device may be interrupted. In existing cluster infrastructures, it is not necessary for the worker nodes to be aware of the owner to which they are registered, since they are usually manually configured to cooperate (e.g. share computational power) by becoming worker nodes of one or more clusters. However, by making use of the knowledge of an owner to which a wireless device is registered, it is advantageously possible to automate the decision on whether to allow the wireless device to join a cluster of worker nodes as a worker node, whilst providing the assurance that the wireless device is in fact authorised to join the cluster in a straightforward manner.

Therefore, according to an aspect of the disclosure, there is provided a first method for managing a cluster of worker nodes that are controllable by a master node. The first method is performed by an entity. The first method comprises automatically allowing a wireless device to join the cluster as a worker node if the wireless device is authorised to join the cluster. The wireless device is authorised to join the cluster if the wireless device is registered to an owner of the master node and/or cluster of worker nodes. The worker nodes are responsible for providing a computational resource in a network.

According to another aspect of the disclosure, there is provided an entity configured to operate in accordance with the first method. In some embodiments, the entity may comprise processing circuitry configured to operate in accordance with the first method. In some embodiments, the entity may comprise at least one memory for storing instructions which, when executed by the processing circuitry, cause the entity to operate in accordance with the first method.

According to another aspect of the disclosure, there is provided a second method for controlling the operation of a wireless device. The method is performed by the wireless device. The method comprises automatically joining a cluster of worker nodes as a worker node if an entity allows the wireless device to join the cluster of worker nodes.

The cluster of worker nodes are controllable by a master node and the worker nodes are responsible for providing a computational resource in a network. The entity allows the wireless device to join the cluster if the wireless device is authorised to join the cluster. The wireless device is authorised to join the cluster if the wireless device is registered to an owner of the master node and/or cluster of worker nodes.

According to another aspect of the disclosure, there is provided a wireless device configured to operate in accordance with the second method. In some embodiments, the wireless device may comprise processing circuitry configured to operate in accordance with the second method. In some embodiments, the wireless device may comprise at least one memory for storing instructions which, when executed by the processing circuitry, cause the wireless device to operate in accordance with the second method.

According to another aspect of the disclosure, there is provided a method performed by a system. The method comprises the first method and the second method.

According to another aspect of the disclosure, there is provided a system. The system comprises the entity and the wireless device.

According to another aspect of the disclosure, there is provided a computer program comprising instructions which, when executed by processing circuitry, cause the processing circuitry to perform the first method and/or the second method.

According to another aspect of the disclosure, there is provided a computer program product, embodied on a non-transitory machine-readable medium, comprising instructions which are executable by processing circuitry to cause the processing circuitry to perform the first method and/or the second method.

Therefore, there are provided advantageous techniques for managing a cluster of network nodes and, accordingly, controlling the operation of a wireless device. In particular, the advantageous techniques provide greater flexibility in provisioning computational resources in the network by enabling automation for wireless devices to join clusters dynamically. Moreover, the greater flexibility is provided in a simple, secure, and reliable manner, without the need for manual input. The advantageous techniques can also be implemented easily since the building blocks for such an implementation are already available to be used in this advantageous manner.

### BRIEF DESCRIPTION OF THE DRAWINGS

For a better understanding of the techniques, and to show how they may be put into effect, reference will now be made, by way of example, to the accompanying drawings, in which:

FIG. 1 is a block diagram illustrating an entity according to an embodiment;

FIG. 2 is a block diagram illustrating a method performed by the entity according to an embodiment;

FIG. 3 is a block diagram illustrating a wireless device according to an embodiment;

FIG. 4 is a block diagram illustrating a method performed by the wireless device according to an embodiment;

FIG. 5A is a block diagram illustrating a wireless device according to an embodiment;

FIG. 5B is a block diagram illustrating a master node according to an embodiment;

FIG. 5C is a block diagram illustrating a node that is separate from a master node and worker nodes according to an embodiment;

FIGS. 6-8 are schematic illustrations of methods performed by a system according to some embodiments;

FIGS. 9-11 are signalling diagrams illustrating an exchange of signals in a system according to some embodiments; and

FIG. 12 is an example of a control architecture according to an embodiment.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, there are described herein advantageous techniques for managing a cluster of worker nodes and, accordingly, controlling the operation of a wireless device. Although the techniques may be described in respect of managing a cluster of worker nodes, it will be understood that the techniques can be implemented for managing a plurality of clusters of worker nodes. Similarly, although the techniques may be described in respect of controlling the operation of a wireless device, it will be understood that the techniques can be implemented for controlling the operation of a plurality of wireless devices. The techniques for controlling the operation of a wireless device can be performed by the wireless device itself. The techniques for managing a cluster of worker nodes can be performed by an entity. The entity and the wireless device described herein may communicate with each other, e.g. over a communication channel, to implement the techniques described herein. In some embodiments, the entity and the wireless device may communicate over the cloud. The techniques described herein can be implemented in the cloud according to some embodiments. The techniques described herein can be computer-implemented.

The cluster of worker nodes referred to herein can, for example, be part of the Internet of Things (IoT) or the Industrial Internet of Things (IIoT). In some embodiments, the cluster of worker nodes referred to herein can be a Kubernetes (K8s) cluster of worker nodes. A K8s cluster of worker nodes is a set of worker nodes that run containerised applications. Although K8s is agnostic to the underlying network infrastructure used to connect devices, given that a certain latency and bandwidth may need to be met depending on the quality of service (QOS) requirements, it is not used in existing techniques in the context where wireless devices are connected on a mobile network. However, it is noted that fifth generation (5G) and sixth generation (6G) mobile networks meet stringent QoS requirements (such as providing ultra-high reliability, while retaining ultra-low latency), and by pairing this with network slicing, most of the internet protocol (IP) configurations required for a correct execution of K8s are achievable. Although a K8s cluster of worker nodes has been provided as one example of the type of cluster of worker nodes, it will be understood that any other type of cluster of worker nodes may be used (such as OpenStack, Docker Swarm, etc.). Specifically, the infrastructure described herein is intended to operate irrespective of the orchestration system.

The worker nodes referred to herein can comprise one or more devices, such as one or more wireless devices. The one or more devices can, for example, comprise one or more robots, surveillance equipment, small control devices, and/or any other wireless devices. The location of the worker nodes referred to herein can be distributed according to some embodiments, such as across a building or premises (e.g. an industrial building or premises). The worker nodes referred to herein can be responsible for providing a computational resource in a network.

The network referred to herein can be any type of network (e.g. a telecommunications network). For example, the network referred to herein can be a cellular or mobile network, such as a fourth generation (4G) mobile network, a fifth generation (5G) mobile network, a sixth generation (6G) mobile network, or any other generation mobile network. In some embodiments, the network referred to herein can be a radio access network (RAN), or any other type of network. In some embodiments, the network referred to herein can be a local network, such as a local area network (LAN). In some embodiments, the network referred to herein can be an edge cloud infrastructure. In some embodiments, the network referred to herein can be a virtual network or an at least partially virtual network.

The advantageous techniques described herein are capable of aiding cluster scalability by automating the management of wireless devices that belong to an owner of a master node and/or cluster of worker nodes and repurposing the computational power of the wireless devices, such as based on particular characteristics (e.g. wireless device location). The advantageous techniques described herein provide a means to handle the steps of cluster management that are typically performed manually by a system administrator (e.g. during scaling of a cluster, which can involve adding and/or removing a worker node). The process of cluster management is automated, while maintaining security and reliability.

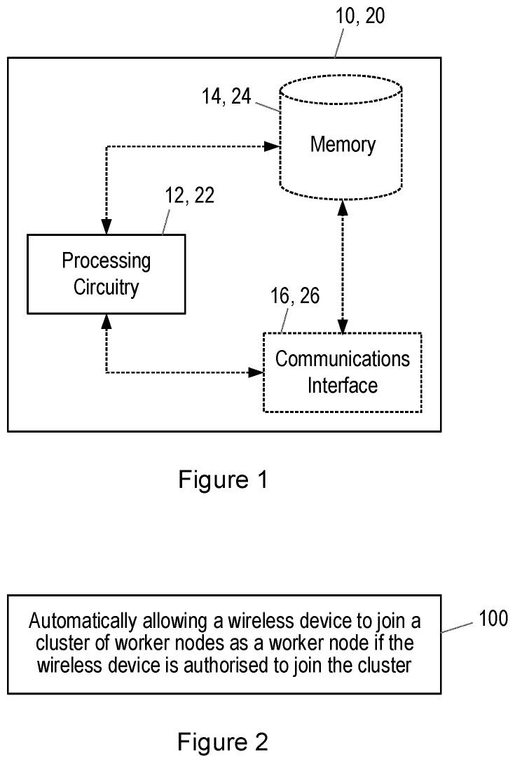

FIG. 1 illustrates an entity 10, 20 in accordance with an embodiment. The entity 10, 20 is for managing a cluster (or set) of worker nodes that are controllable by a master node 10. In some embodiments, the entity can itself be the master node 10. In other embodiments, the entity may be a node 20 that is separate from the master node 10 and the worker nodes. For example, according to some embodiments, the entity 20 can be a central entity, such as a central controller, or central mobility and security manager. The entity 20 may be “central” in terms of its location with respect to the worker nodes and optionally also the master node 10. For example, the entity 20 may be located (as close as possible to) an equal distance from each worker node and optionally also the master node 10. In some embodiments where the entity is a node 20 that is separate from the master node 10 and the worker nodes, the entity 20 can reside at a different location from the worker nodes and the master node 10. However, in other embodiments, the entity 20 may reside at the same location as the worker nodes and/or the master node 10. In some embodiments, the node 20 that is separate from the master node 10 may be implemented as a user plane function (UPF) service, a virtual network function (VNF), or an application function (AF).

The entity 10, 20 referred to herein can refer to equipment capable, configured, arranged and/or operable to communicate directly or indirectly with any one or more of the master node 10 (e.g. where the entity is a node 20 that is separate from the master node 10), the worker nodes, the wireless device, and the node 20 that is separate from the master node 10 (e.g. where the entity is the master node 10), and/or with other entities or equipment to enable and/or to perform the functionality described herein. The entity 10, 20 referred to herein may be a physical entity (e.g. a physical machine) or a virtual entity (e.g. a virtual machine, VM).

As illustrated in FIG. 1, the entity 10, 20 comprises processing circuitry (or logic) 12. The processing circuitry 12, 22 controls the operation of the entity 10, 20 and can implement the method described herein in respect of the entity 10, 20. The processing circuitry 12, 22 can be configured or programmed to control the entity 10, 20 in the manner described herein. The processing circuitry 12, 22 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the entity 10, 20. In some embodiments, the processing circuitry 12, 22 can be configured to run software to perform the method described herein in respect of the entity 10, 20. The software may be containerised according to some embodiments. Thus, in some embodiments, the processing circuitry 12, 22 may be configured to run a container to perform the method described herein in respect of the entity 10, 20.

Briefly, the processing circuitry 12, 22 of the entity 10, 20 is configured to automatically allow a wireless device to join (e.g. participate in) the cluster as a worker node if the wireless device is authorised to join the cluster. The wireless device is authorised to join the cluster if the wireless device is registered to an owner of the master node 10 and/or cluster of worker nodes. The worker nodes are responsible for providing a computational resource in a network.

As illustrated in FIG. 1, in some embodiments, the entity 10, 20 may optionally comprise a memory 14, 24. The memory 14, 24 of the entity 10, 20 can comprise a volatile memory or a non-volatile memory. In some embodiments, the memory 14, 24 of the entity 10, 20 may comprise a non-transitory media. Examples of the memory 14, 24 of the entity 10, 20 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 12, 22 of the entity 10, 20 can be connected to the memory 14, 24 of the entity 10, 20. In some embodiments, the memory 14, 24 of the entity 10, 20 may be for storing program code or instructions which, when executed by the processing circuitry 12, 22 of the entity 10, 20, cause the entity 10, 20 to operate in the manner described herein in respect of the entity 10, 20. For example, in some embodiments, the memory 14, 24 of the entity 10, 20 may be configured to store program code or instructions that can be executed by the processing circuitry 12, 22 of the entity 10, 20 to cause the entity 10, 20 to operate in accordance with the method described herein in respect of the entity 10, 20. Alternatively or in addition, the memory 14, 24 of the entity 10, 20 can be configured to store any information, data, messages, requests, responses, indications, notifications, signals, or similar, that are described herein. The processing circuitry 12, 22 of the entity 10, 20 may be configured to control the memory 14, 24 of the entity 10, 20 to store information, data, messages, requests, responses, indications, notifications, signals, or similar, that are described herein.

In some embodiments, as illustrated in FIG. 1, the entity 10, 20 may optionally comprise a communications interface 16, 26. The communications interface 16, 26 of the entity 10, 20 can be connected to the processing circuitry 12, 22 of the entity 10, 20 and/or the memory 14, 24 of the entity 10, 20. The communications interface 16, 26 of the entity 10, 20 may be operable to allow the processing circuitry 12, 22 of the entity 10, 20 to communicate with the memory 14, 24 of the entity 10, 20 and/or vice versa. Similarly, the communications interface 16, 26 of the entity 10, 20 may be operable to allow the processing circuitry 12, 22 of the entity 10, 20 to communicate with any one or more of the other entities, devices, and/or nodes (e.g. the wireless device, the master node 10, the node 20, and/or the worker nodes) referred to herein. The communications interface 16, 26 of the entity 10, 20 can be configured to transmit and/or receive information, data, messages, requests, responses, indications, notifications, signals, or similar, that are described herein. In some embodiments, the processing circuitry 12, 22 of the entity 10, 20 may be configured to control the communications interface 16, 26 of the entity 10, 20 to transmit and/or receive information, data, messages, requests, responses, indications, notifications, signals, or similar, that are described herein.

Although the entity 10, 20 is illustrated in FIG. 1 as comprising a single memory 14, 24, it will be appreciated that the entity 10, 20 may comprise at least one memory (i.e. a single memory or a plurality of memories) 14, 24 that operate in the manner described herein. Similarly, although the entity 10, 20 is illustrated in FIG. 1 as comprising a single communications interface 16, 26, it will be appreciated that the entity 10, 20 may comprise at least one communications interface (i.e. a single communications interface or a plurality of communications interfaces) 16, 26 that operate in the manner described herein. It will also be appreciated that FIG. 1 only shows the components required to illustrate an embodiment of the entity 10, 20 and, in practical implementations, the entity 10, 20 may comprise additional or alternative components to those shown.

FIG. 2 illustrates a method performed by the entity 10, 20 in accordance with an embodiment. The method is for managing a cluster (or set) of worker nodes that are controllable by a master node 10. In some embodiments, a node can be delegated as the master node 10 by which the worker nodes are controllable. For example, an owner of the cluster of worker nodes may delegate a node as the master node. In some embodiments, the master node 10 may itself be a worker node or may have previously been a worker node. In other embodiments, the master node 10 may be a different node to the worker nodes. The entity 10, 20 described earlier with reference to FIG. 1 can be configured to operate in accordance with the method of FIG. 2. The method can be performed by or under the control of the processing circuitry 12, 22 of the entity 10, 20 according to some embodiments.

With reference to FIG. 2, as illustrated in block 100, a wireless device is automatically allowed (or authenticated) to join (e.g. participate in) the cluster of worker nodes as a worker node if the wireless device is authorised to join the cluster. The wireless device is authorised to join the cluster if the wireless device is registered to an owner of the master node 10 and/or cluster of worker nodes. The worker nodes are responsible for providing a computational resource (e.g. computing power) in a network. Generally, all devices that are (e.g. part of a premises, such as an industrial premises, and) capable of fulfilling some computational task can be used as a worker node as they may be capable of providing a computational resource. Herein, the term “automatically” can refer to a step being performed without manual input (e.g. without input from the owner of the worker nodes or master node). As the wireless device referred to herein may join the cluster of worker nodes as a worker node, the wireless device may also be referred to as the prospective worker node.

In some embodiments, the owner of the master node 10 and/or cluster of worker nodes can be a user of the master node 10 and/or cluster of worker nodes, a service provider of the master node 10 and/or cluster of worker nodes, or a manager of the master node 10 and/or cluster of worker nodes. In some embodiments where the owner of the master node 10 and/or cluster of worker nodes is the manager of the master node 10 and/or cluster of worker nodes, the wireless device may be authorised to join the cluster if the wireless device is registered to the manager and a user of the wireless device is authorised by the manager to use the wireless device.

Herein, a user can be a user that uses the master node 10 and/or cluster of worker nodes. Herein, a service provider can be a provider of a service to the master node 10 and/or cluster of worker nodes. For example, the service provider may be an internet service provider (ISP). In some examples, one or more of the worker nodes and/or the master node 10 may comprise a subscriber identification module (SIM) card or embedded subscriber identification module (e-SIM) provided by the service provider (e.g. ISP). Herein, a manager can be a manager that manages the master node 10 and/or cluster of worker nodes For example, a manager can be a company and/or organisation to which the master node 10 and/or cluster of worker nodes are registered.

Although not illustrated in FIG. 2, in some embodiments, the method may comprise automatically disallowing the wireless device from joining the cluster as a worker node if the wireless device is not authorised to join the cluster. More specifically, the entity 10, 20 (e.g. the processing circuitry 12, 22 of the entity 10, 20) can be configured to disallow the wireless device from joining the cluster in this situation according to some embodiments. The wireless device may not be authorised to join the cluster if the wireless device is not registered to the owner of the master node 10 and/or cluster of worker nodes.

In some embodiments, the wireless device may be automatically allowed to join the cluster when the wireless device moves into a geographical area served by the cluster or moves into a part of the network served by the cluster. More specifically, the entity 10, 20 (e.g. the processing circuitry 12, 22 of the entity 10, 20) can be configured to automatically allow the wireless device to join the cluster if such a situation arises according to some embodiments. A geographical area served by the cluster may be, for example, the premises (e.g. industrial premises) of the owner of the cluster and/or the surrounding outside area. Herein, a part of the network served by the cluster may, for example, be a cell of the network and/or a network slice. Herein, a network slice can be defined as an (e.g. isolated, separate, or self-contained) end-to-end network. A network slice can be a portion of the network. For example, in an embodiment where the network is a physical network, a network slice may be a portion of the physical network that connects two or more logical networks (e.g. interfaces or devices).

Although not illustrated in FIG. 2, in some embodiments, the method may comprise determining if the wireless device is authorised to join the cluster. More specifically, the entity 10, 20 (e.g. the processing circuitry 12, 22 of the entity 10, 20) can be configured to make this determination according to some embodiments. In other embodiments, another entity or node may be configured to make the determination and notify the entity 10, 20 accordingly.

In some embodiments, the wireless device can be authorised to join the cluster if the wireless device has a public key that corresponds to a private key of the master node 10. For example, the master node 10 may have a private key associated with (e.g. assigned to) it and this private key can have a corresponding public key. Thus, keys may be required for automatically allowing the wireless device to join the cluster according to some embodiments. The generation of such keys can be part of a default operation. In some embodiments, one or both of the public key and the private key may be set by the owner of the master node 10 and/or cluster of worker nodes. Alternatively or in addition, in some embodiments, one or both of the public key and the private key may be modifiable by the owner of the master node 10 and/or cluster of worker nodes. For example, in some embodiments, the owner may be able to create, edit, and/or delete one or both of the public key and the private key.

Herein, the private key and corresponding public key can be referred to as a private/public key pair. The owner of the master node 10 and/or cluster of worker nodes may need a guarantee that only authorised wireless devices can join their cluster and the use of such a public/private key pair can provide a simple and safe way to verify such a guarantee. It also avoids human error, which can occur when a manual verification is used. This can be particularly valuable in industrial settings, which make use of smaller dedicated clusters, since access security can be more easily managed in this way.

Although not illustrated in FIG. 2, in some embodiments, the method may comprise acquiring the private key from a memory of the master node 10. Alternatively or in addition, the method may comprise acquiring the private key from a node 20 that is separate from the master node 10 and worker nodes, such as a node of a (e.g. centralised) key management system. More specifically, the entity 10, 20 (e.g. the processing circuitry 12, 22 of the entity 10, 20) can be configured to acquire the private key (e.g. via the communications interface 16, 26 of the entity 10, 20) according to some embodiments. In some of these embodiments, acquiring the private key from the node 20 that is separate from the master node 10 and worker nodes may comprise initiating transmission of a request for the private key towards the node 20 that is separate from the master node 10 and worker nodes, and receiving a response from the node 20 that is separate from the master node 10 and worker nodes, wherein the response comprises the private key. More specifically, the entity 10, 20 (e.g. the processing circuitry 12, 22 of the entity) can be configured to initiate the transmission of this request according to some embodiments. Herein, the term “initiate” can mean, for example, cause or establish. Thus, the entity 10, 20 (e.g. the processing circuitry 12, 22 of the entity 10, 20) can be configured to itself transmit the request (e.g. via a communications interface 16, 26 of the entity 10, 20) or can be configured to cause another entity to transmit the request. Similarly, according to some embodiments, the entity 10, 20 (e.g. the processing circuitry 12, 22 of the entity, such as via the communications interface 16, 26 of the entity 10, 20) can be configured to receive the response to the request.

Although not illustrated in FIG. 2, in some embodiments, the method may comprise initiating transmission of the public key towards the wireless device. More specifically, the entity 10, 20 (e.g. the processing circuitry 12, 22 of the entity) can be configured to initiate this transmission of the public key according to some embodiments. For example, the entity 10, 20 (e.g. the processing circuitry 12, 22 of the entity 10, 20) can be configured to itself transmit the public key (e.g. via a communications interface 16 of the entity 10, 20) or can be configured to cause another entity to transmit the public key according to some embodiments. In some embodiments, transmission of the public key towards the wireless device may be initiated in response to receiving a request for the public key from the wireless device. For example, the entity 10, 20 (e.g. the processing circuitry 12, 22 of the entity 10, 20) can be configured to receive (e.g. via a communications interface 16 of the entity 10, 20) the request for the public key from the wireless device according to some embodiments.

In some embodiments, the method may comprise assigning the keys for each worker node, prospective worker node, and cluster. More specifically, the entity 10, 20 (e.g. the processing circuitry 12, 22 of the entity 10, 20) can be configured to assign these keys according to some embodiments. In some embodiments, any communication that occurs between the master node 10 and worker nodes (e.g. during the bootstrapping process that will be described later or any other process described herein) may be encrypted using the assigned keys. The management of these keys can be removed from the typical responsibilities of the owner, by automating the key generation process.

Although not illustrated in FIG. 2, in some embodiments, the method may comprise automatically allowing the wireless device to leave the cluster. More specifically, the entity 10, 20 (e.g. the processing circuitry 12, 22 of the entity 10, 20) can be configured to automatically allow the wireless device to leave the cluster according to some embodiments. In some embodiments, the method may comprise automatically allowing the wireless device to leave the cluster when the wireless device moves outside the geographical area served by the cluster or moves outside the part of the network served by the cluster.

In some embodiments, the method described with reference to FIG. 2 may be performed in response to the entity 10 receiving a first request transmitted from the wireless device towards the entity 10. Thus, in some embodiments, the entity 10 (e.g. the processing circuitry 12 of the entity 10) can be configured to receive the first request (e.g. via the communications interface 16 of the entity 10). The first request can be a request for the wireless device to connect to the master node 10. Alternatively or in addition, in some embodiments, the method described with reference to FIG. 2 may be performed in response to the entity 10 receiving a second request broadcast from the wireless device. Thus, in some embodiments, the entity 10 (e.g. the processing circuitry 12 of the entity 10) can be configured to receive the second request (e.g. via the communications interface 16 of the entity 10). The second request can be a request to discover a master node 10 to which the wireless device is connectable. Herein, connectable can mean, for example, that the wireless device is (e.g. potentially) able to connect to a master node 10. In some embodiments, the first request and/or the second request may be received through a representational state transfer application programming interface (REST API). In some embodiments, the first request and/or the second request may be received through a wired connection (e.g. one or more direct network sockets) or wireless connection.

The process of the wireless device 30 joining the cluster of worker nodes may be referred to herein as a bootstrapping process. The wireless device 30 may join the cluster of worker nodes by connecting to the respective master node 10, i.e. the master node 10 that is responsible for controlling the worker nodes of the cluster. Thus, in some embodiments, the bootstrapping process can comprise initiating transmission of information towards the wireless device 30, where the information is that which is necessary for the wireless device 30 to connect to the master node 10. For example, the information can comprise an (e.g. IP or virtual IP) address for the master node 10.

Thus, although not illustrated in FIG. 2, in some embodiments, the method may comprise, if the wireless device is authorised to join the cluster, initiating transmission of an (e.g. IP or virtual IP) address for the master node 10 towards the wireless device to allow the wireless device to connect to the master node 10. More specifically, the entity 10, 20 (e.g. the processing circuitry 12, 22 of the entity 10, 20) can be configured to initiate the transmission of this address according to some embodiments. For example, the entity 10, 20 (e.g. the processing circuitry 12, 22 of the entity 10, 20) can be configured to itself transmit (e.g. via a communications interface 16, 26 of the entity 10, 20) the address or can be configured to cause another entity to transmit the address. After the information necessary for the wireless device 30 to connect to the master node 10 has been transmitted towards the wireless device 30, the bootstrapping process can be considered complete.

In some embodiments, the information exchanged in the bootstrapping process may comprise information used for the configuration process and/or any cluster commands (e.g. a join command, such as a Kubernetes join command). In some embodiments, the bootstrapping process may also optionally comprise initiating transmission of an acknowledgement at one or more (or each) step of the bootstrapping process. Thus, according to some embodiments, the entity 10, 20 (e.g. the processing circuitry 12, 22 of the entity 10, 20) can be configured to itself transmit any acknowledgments (e.g. via the communications interface 16 of the entity 10, 20) or can be configured to cause another entity to transmit any acknowledgements.

Although also not illustrated in FIG. 2, in some embodiments, the method may comprise identifying the master node 10 from a plurality of master nodes based on a location of the wireless device and a location of each of the plurality of master nodes. More specifically, the entity 10, 20 (e.g. the processing circuitry 12, 22 of the entity 10, 20) can be configured to perform this identification according to some embodiments. In some embodiments, this identification can comprise identifying the master node 10 from the plurality of master nodes as the master node that is in the same geographical area as the wireless device or the same part of the network as the wireless device.

Although also not illustrated in FIG. 2, in some embodiments, the method may comprise receiving, from the master node 10, information indicative of a location of the master node 10, and/or receiving, from the wireless device, information indicative of a location of the wireless device. More specifically, the entity 10, 20 (e.g. the processing circuitry 12, 22 of the entity 10, 20) can be configured to receive this information (e.g. via a communications interface 16, 26 of the entity 10, 20) according to some embodiments.

Although also not illustrated in FIG. 2, in some embodiments, the method may comprise assigning a virtual private network (VPN) to the master node 10. More specifically, the entity 10, 20 (e.g. the processing circuitry 12, 22 of the entity 10, 20) can be configured to perform this assignment according to some embodiments. In other embodiments, another entity may be configured to assign a VPN to the master node 10. In some embodiments, the method may comprise, if the wireless device is authorised to join the cluster, connecting the wireless device to the VPN assigned to the master node 10. More specifically, the entity 10, 20 (e.g. the processing circuitry 12, 22 of the entity 10, 20) can be configured to connect the wireless device to this VPN according to some embodiments.

Although also not illustrated in FIG. 2, in some embodiments, the method may comprise providing information about the master node 10 (or one or more master nodes managed by the entity 10, 20) periodically or in response to a request for the information, e.g. from the wireless device, one or more master nodes, and/or one or more worker nodes. More specifically, the entity 10, 20 (e.g. the processing circuitry 12, 22 of the entity 10, 20) can be configured to provide this information according to some embodiments. For example, periodically or in response to the request for the information, transmission of the information may be initiated, e.g. towards the wireless device, one or more master nodes, and/or one or more worker nodes. More specifically, the entity 10, 20 (e.g. the processing circuitry 12, 22 of the entity 10, 20) can be configured to itself transmit (e.g. via a communications interface 16, 26 of the entity 10, 20), or cause another node to transmit, this information according to some embodiments. Herein, the term periodically can mean, for example, at predefined intervals in time, or in response to a predefined trigger (e.g. when a property of the master node 10 is updated). In some embodiments, the information about the master node 10 (or one or more master nodes managed by the entity 10, 20) can comprise an identity (ID) and/or an address (e.g. IP address or virtual IP address) of the master node 10 (or one or more master nodes managed by the entity 10, 20). In some embodiments, information identifying the master node 10 (or one or more master nodes managed by the entity 10, 20) may be set by the owner of the master node 10 and/or may be modifiable by the owner of the master node 10.

Although not illustrated in FIG. 2, in some embodiments, the method may comprise terminating (e.g. destroying) an address assigned to the wireless device when (e.g. as soon as) the wireless device is unreachable within the network for a predefined amount of time (e.g. 24 hours or any other predefined amount of time, such as any threshold specified by the user of the wireless device). More specifically, the entity 10, 20 (e.g. the processing circuitry 12, 22 of the entity 10, 20) can be configured to terminate this address according to some embodiments. In other embodiments, the method may comprise storing the address assigned to the wireless device when the wireless device is unreachable within the network for the predefined amount of time for the address to be available for reassignment to the wireless device when the wireless device is reachable within the network. More specifically, according to other embodiments, the entity 10, 20 (e.g. the processing circuitry 12, 22 of the entity 10, 20) can be configured to store this address, e.g. in the memory 14, 24 of the entity 10, 20 and/or any other memory. Thus, in these other embodiments, the address assigned to the wireless device can be kept for reassignment of that same address to the wireless device later, e.g. whenever the wireless device returns to the same location.

By terminating or storing the address assigned to the wireless device in the manner described here, it is possible to avoid address conflicts in the network. In some embodiments, the address assigned to the wireless device may be assigned to the wireless device by a private network, e.g. a virtual private network (VPN). In some embodiments, the address assigned to the wireless device may be an IP address or a virtual IP address. A flexible management of virtual network overlays and their IP addresses means that the number of entities 10, 20 can be scalable. In some embodiments, the entity 10, 20 may represent an isolated section of the infrastructure described herein.

Although not illustrated in FIG. 2, in some embodiments, the method may comprise administrating the wireless device, such as by checking its identity (e.g. the mobile network identity) or address (e.g. IP address or virtual IP address provided by the mobile network). More specifically, the entity 10, 20 (e.g. the processing circuitry 12, 22 of the entity 10, 20) can be configured to perform this administration according to some embodiments. In some embodiments, the method may comprise assigning an (e.g. IP or virtual IP) address to the wireless device 30 (e.g. for a virtual overlay network). More specifically, the entity 10, 20 (e.g. the processing circuitry 12, 22 of the entity 10, 20) can be configured to assign this virtual address according to some embodiments.

In some embodiments, the master node 10 referred to herein can be one of a plurality of master nodes and the cluster of worker nodes can be one of a plurality of clusters of worker nodes. In these embodiments, each cluster of worker nodes can be controllable by a respective master node 10. For example, an owner can have multiple clusters of worker nodes, with each cluster being controllable by a respective master node. In some of these embodiments, the method may comprise automatically allowing the wireless device to join any cluster of worker nodes where the wireless device is registered to an owner of that cluster of worker nodes and/or the respective master node 10. More specifically, the entity 10, 20 (e.g. the processing circuitry 12, 22 of the entity 10, 20) can be configured to automatically allow the wireless device to join any cluster of worker nodes where this is the case. In some embodiments, the method can comprise an administrating step, which comprises authenticating the wireless device with all master nodes that belong to the owner to which the wireless device is registered.

The entity 10, 20 referred to herein can be used by a service provider to provide a service to the owner of the master node 10 and/or cluster of worker nodes. The service is the management of the cluster of worker nodes, which may also be referred to as cluster management (or, more specifically, cluster access management). In some embodiments, the entity 10, 20 and thus the service may (e.g. always) be reachable by the master node 10 (where the entity is a node 20 that is separate from the master node 10) and/or the worker nodes. In some embodiments, an owner (or each owner) of one or more clusters of worker nodes may specify an identity (such as a name or other univocal identifier, other than an IP address) of a respective master node 10 and/or the public/private key pair that is to be used for authentication. In some embodiments, this information may be created, deleted, and/or modified by the owner (e.g. at any time).

In some embodiments, the entity referred to herein may be the master node 10. In some embodiments, the entity referred to herein may be a node 20 that is separate from the master node 10 and worker nodes. In some embodiments, where the entity is the node 20 that is separate from the master node 10 and worker nodes, the entity 20 may reside at a different location from the worker nodes and the master node 10. In some embodiments, any one or more of the master node 10, the worker nodes, the node 20 that is separate from the master node 10, and the wireless device may reside at different locations from each other. For example, the master node 10, the worker nodes, and the node 20 that is separate from the master node 10 and worker nodes may reside at three respective locations according to some embodiments. In embodiments where the master node 10, the worker nodes, and the node 20 that is separate from the master node 10 and worker nodes reside at different locations, these nodes do not structurally depend on each other and they can thus be completely decoupled from one another. For example, in some embodiments, the dependency between these nodes may only be functional, e.g. data related. In some embodiments, the master node 10 and worker nodes may reside at the same location (e.g. at a site of the owner) and the node 20 that is separate from the master node 10 and worker nodes may reside at a different location (e.g. at a property of a service provider). In other embodiments, where the entity is the node 20 that is separate from the master node 10 and worker nodes, the entity 20 may still reside at the same location as the worker nodes and the master node 10.

In some embodiments, the master node 10 referred to herein may be one of the worker nodes. In other embodiments, the master node 10 referred to herein may be a different node to the worker nodes.

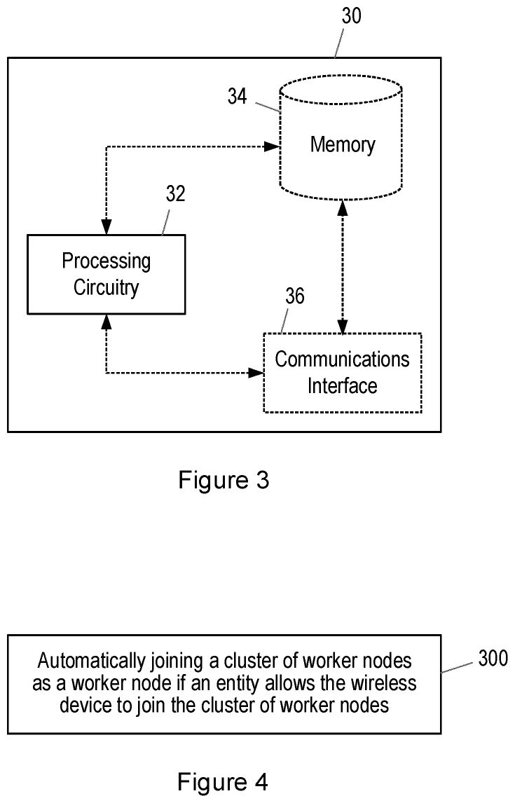

FIG. 3 illustrates a wireless device 30 in accordance with an embodiment. The wireless device 30 referred to herein can refer to a device capable, configured, arranged and/or operable to communicate wirelessly (and directly or indirectly) with any one or more of the entity 10, 20, the master node 10 (e.g. where the entity is a node 20 that is separate from the master node 10), the node 20 that is separate from the master node 10 (e.g. where the entity is the master node 10), and the worker nodes, and/or with other entities or equipment to enable and/or to perform the functionality described herein. The wireless device 30 referred to herein may be a physical entity (e.g. a physical machine) or a virtual entity (e.g. a virtual machine, VM). Unless otherwise noted, the term wireless device 30 may be used interchangeably herein with user equipment (UE).

Herein, communicating wirelessly may involve transmitting and/or receiving wireless signals using electromagnetic waves, radio waves, infrared waves, and/or other types of signals suitable for conveying information through air. In some embodiments, the wireless device 30 may be configured to transmit and/or receive information without direct human interaction. For instance, the wireless device 30 may be designed to transmit information to a network on a predetermined schedule, when triggered by an internal or external event, or in response to requests from the network.

Examples of the wireless device 30 include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. The wireless device 30 may support device-to-device (D2D) communication, for example, by implementing a third generation partnership project (3GPP) standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, the wireless device 30 may represent a machine or other device that performs monitoring and/or measurements, and transmits the results of such monitoring and/or measurements to another wireless device and/or a network node. The wireless device 30 may in this case be a machine-to-machine (M2M) device, which may in a 3GPP context be referred to as a machine type communication (MTC) device. As one particular example, the wireless device 30 may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc), personal wearables (e.g. watches, fitness trackers, etc). In other scenarios, the wireless device 30 may represent a vehicle or other equipment that is capable of monitoring and/or reporting on its operational status or other functions associated with its operation. The wireless device 30 as described herein may represent the endpoint of a wireless connection, in which case the wireless device 30 may be referred to as a wireless terminal. Furthermore, the wireless device 30 as described herein may be mobile, in which case it may also be referred to as a mobile device or a mobile terminal.

As illustrated in FIG. 3, the wireless device 30 comprises processing circuitry (or logic) 12. The processing circuitry 32 controls the operation of the wireless device 30 and can implement the method described herein in respect of the wireless device 30. The processing circuitry 32 can be configured or programmed to control the wireless device 30 in the manner described herein. The processing circuitry 32 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the wireless device 30. In some embodiments, the processing circuitry 32 can be configured to run software to perform the method described herein in respect of the wireless device 30. The software may be containerised according to some embodiments. Thus, in some embodiments, the processing circuitry 32 may be configured to run a container to perform the method described herein in respect of the wireless device 30.

Briefly, the processing circuitry 32 of the wireless device 30 is configured to automatically join (e.g. participate in) a cluster (or set) of worker nodes as a worker node if the entity 10, 20 described earlier allows the wireless device 30 to join the cluster of worker nodes.

The cluster of worker nodes are controllable by a master node 10 and the worker nodes are responsible for providing a computational resource in a network. As described earlier, the entity 10, 20 allows the wireless device 30 to join the cluster if the wireless device 30 is authorised to join the cluster and the wireless device 30 is authorised to join the cluster if the wireless device 30 is registered to an owner of the master node 10 and/or cluster of worker nodes.

As illustrated in FIG. 3, in some embodiments, the wireless device 30 may optionally comprise a memory 34. The memory 34 of the wireless device 30 can comprise a volatile memory or a non-volatile memory. In some embodiments, the memory 34 of the wireless device 30 may comprise a non-transitory media. Examples of the memory 34 of the wireless device 30 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 32 of the wireless device 30 can be connected to the memory 34 of the wireless device 30. In some embodiments, the memory 34 of the wireless device 30 may be for storing program code or instructions which, when executed by the processing circuitry 32 of the wireless device 30, cause the wireless device 30 to operate in the manner described herein in respect of the wireless device 30. For example, in some embodiments, the memory 34 of the wireless device 30 may be configured to store program code or instructions that can be executed by the processing circuitry 32 of the wireless device 30 to cause the wireless device 30 to operate in accordance with the method described herein in respect of the wireless device 30. Alternatively or in addition, the memory 34 of the wireless device 30 can be configured to store any information, data, messages, requests, responses, indications, notifications, signals, or similar, that are described herein. The processing circuitry 32 of the wireless device 30 may be configured to control the memory 34 of the wireless device 30 to store information, data, messages, requests, responses, indications, notifications, signals, or similar, that are described herein.

In some embodiments, as illustrated in FIG. 3, the wireless device 30 may optionally comprise a communications interface 36. The communications interface 36 of the wireless device 30 can be connected to the processing circuitry 32 of the wireless device 30 and/or the memory 34 of the wireless device 30. The communications interface 36 of the wireless device 30 may be operable to allow the processing circuitry 32 of the wireless device 30 to communicate with the memory 34 of the wireless device 30 and/or vice versa. Similarly, the communications interface 36 of the wireless device 30 may be operable to allow the processing circuitry 32 of the wireless device 30 to communicate with any one or more of the other entities, devices, and/or nodes (e.g. the entity 10, 20, the master node 10, the node 20, and/or the worker nodes) referred to herein. The communications interface 36 of the wireless device 30 can be configured to transmit and/or receive information, data, messages, requests, responses, indications, notifications, signals, or similar, that are described herein. In some embodiments, the processing circuitry 32 of the wireless device 30 may be configured to control the communications interface 36 of the wireless device 30 to transmit and/or receive information, data, messages, requests, responses, indications, notifications, signals, or similar, that are described herein.

Although the wireless device 30 is illustrated in FIG. 3 as comprising a single memory 34, it will be appreciated that the wireless device 30 may comprise at least one memory (i.e. a single memory or a plurality of memories) 34 that operate in the manner described herein. Similarly, although the wireless device 30 is illustrated in FIG. 3 as comprising a single communications interface 36, it will be appreciated that the wireless device 30 may comprise at least one communications interface (i.e. a single communications interface or a plurality of communications interface) 36 that operate in the manner described herein. It will also be appreciated that FIG. 3 only shows the components required to illustrate an embodiment of the wireless device 30 and, in practical implementations, the wireless device 30 may comprise additional or alternative components to those shown.

FIG. 4 illustrates a method performed by the wireless device 30 in accordance with an embodiment. The method is for controlling the operation of a wireless device 30. The wireless device 30 described earlier with reference to FIG. 3 can be configured to operate in accordance with the method of FIG. 4. The method can be performed by or under the control of the processing circuitry 32 of the wireless device 30 according to some embodiments.

With reference to FIG. 4, as illustrated in block 300, the wireless device 30 automatically joins (e.g. participate in) a cluster (or set) of worker nodes as a worker node if the entity 10, 20 allows the wireless device 30 to join the cluster of worker nodes. The cluster of worker nodes are controllable by a master node 10 and the worker nodes are responsible for providing a computational resource in a network. As described earlier, the entity 10, 20 allows the wireless device 30 to join the cluster if the wireless device 30 is authorised to join the cluster and the wireless device 30 is authorised to join the cluster if the wireless device 30 is registered to an owner of the master node and/or cluster of worker nodes.

As described earlier, in some embodiments, the owner of the master node 10 and/or cluster of worker nodes can be a user of the master node 10 and/or cluster of worker nodes, a service provider of the master node 10 and/or cluster of worker nodes, or a manager of the master node 10 and/or cluster of worker nodes. As also described earlier, in some embodiments where the owner of the master node 10 and/or cluster of worker nodes is the manager of the master node 10 and/or cluster of worker nodes, the wireless device 30 may be authorised to join the cluster if the wireless device is registered to the manager and a user of the wireless device 30 is authorised by the manager to use the wireless device 30.

In some embodiments, the wireless device 30 may not be authorised to join the cluster if the wireless device 30 is not registered to an owner of the master node 10 and/or the cluster of worker nodes. In some embodiments where the owner of the master node 10 and/or cluster of worker nodes is the manager of the master node 10 and/or cluster of worker nodes, the wireless device 30 may not be authorised to join the cluster if the wireless device is not registered to the manager and/or the user of the wireless device 30 is not authorised by the manager to use the wireless device 30.

In some embodiments, the cluster may be automatically joined when the wireless device 30 moves into a geographical area served by the cluster or moves into a part of the network served by the cluster. More specifically, the wireless device 30 (e.g. the processing circuitry 32 of the wireless device 30) can be configured to automatically join the cluster if such a situation arises according to some embodiments. In some embodiments, the wireless device may be (e.g. automatically) configured according to the (e.g. IP or virtual IP) address settings of the cluster that it joins and/or may be configured to adhere to the (e.g. IP) policies of this cluster.

In some embodiments, the wireless device 30 can be authorised to join the cluster if the wireless device 30 has a public key that corresponds to a private key of the master node 10. In some of these embodiments, one or both of the public key and the private key may be set by the owner of the master node 10 and/or cluster of worker nodes. Alternatively or in addition, in some embodiments, one or both of the public key and the private key may be modifiable by the owner of the master node 10 and/or cluster of worker nodes.

Although not illustrated in FIG. 4, in some embodiments, the method may comprise receiving the public key from the entity 10, 20. More specifically, the wireless device 30 (e.g. the processing circuitry 32 of the wireless device 30) can be configured to receive the public key (e.g. via the communications interface 36 of the wireless device 30) according to some embodiments. In some embodiments, the method may comprise initiating transmission of a request for the public key towards the entity 10, 20, and receiving the public key in response to the request. More specifically, the wireless device 30 (e.g. the processing circuitry 32 of the wireless device 30) can be configured to itself transmit the request (e.g. via a communications interface 36 of the wireless device 30) or can be configured to cause another entity to transmit the request.

Although not illustrated in FIG. 4, in some embodiments, the method may comprise automatically leaving the cluster. More specifically, the wireless device 30 (e.g. the processing circuitry 32 of the wireless device 30) can be configured to automatically leave the cluster according to some embodiments. In some embodiments, the method may comprise automatically leaving the cluster when the wireless device 30 moves outside the geographical area served by the cluster or moves outside the part of the network served by the cluster.

Although also not illustrated in FIG. 4, in some embodiments, the method may comprise initiating transmission of a first request towards the entity 10. More specifically, the wireless device 30 (e.g. the processing circuitry 32 of the wireless device 30) can be configured to itself transmit (e.g. via the communications interface 36 of the wireless device 30) or cause another entity to transmit the first request. The first request is a request for the wireless device 30 to connect to the master node 10. Alternatively or in addition, in some embodiments, the method may comprise broadcasting a second request. More specifically, the wireless device 30 (e.g. the processing circuitry 32 of the wireless device 30) can be configured to broadcast (e.g. via the communications interface 36 of the wireless device 30) the second request. The second request is a request to discover a master node 10 to which the wireless device 30 is connectable. In some embodiments, the transmission of the first request may be initiated through, and/or the broadcast of the second request may be through, a representational state transfer application programming interface (REST API). In some embodiments, transmission of the first request may be initiated through, and/or the broadcast of the second request may be through, a wired connection (e.g. one or more direct network sockets) or a wireless connection.

As mentioned earlier, the process of the wireless device 30 joining the cluster of worker nodes may be referred to herein as a bootstrapping process and the wireless device 30 may join the cluster of worker nodes by connecting to the respective master node 10, i.e. the master node 10 that is responsible for controlling the worker nodes of the cluster.

Thus, in some embodiments, the bootstrapping process at the wireless device 30 can comprise receiving information from the entity 10, 20, where the information is that which is necessary for the wireless device 30 to connect to the master node 10. For example, the information can comprise the (e.g. IP or virtual IP) address for the master node 10 as mentioned earlier.

Thus, although not illustrated in FIG. 4, in some embodiments, the method may comprise, if the wireless device 30 is authorised to join the cluster, receiving the (e.g. IP or virtual IP) address for the master node 10 from the entity 10, 20 to allow the wireless device 30 to connect to the master node 10. More specifically, the wireless device 30 (e.g. the processing circuitry 32 of the wireless device 30) can be configured to receive (e.g. via a communications interface 36 of the wireless device 30) this address according to some embodiments. As mentioned earlier, after the information necessary for the wireless device 30 to connect to the master node 10 has been transmitted towards the wireless device 30, the bootstrapping process can be considered complete. However, in the case of a failure of the bootstrapping process, such as the wireless device 30 failing to connect to the master node 10, the wireless device 30 may reinitiate the bootstrapping process, such as by initiating transmission of a third request towards the entity 10, 20, where the third request is a request for the wireless device to connect to the master node 10.

Although not illustrated in FIG. 4, in some embodiments, the method may comprise initiating transmission of information towards the entity 10, 20, where the information is indicative of a location of the wireless device 30. More specifically, the wireless device 30 (e.g. the processing circuitry 32 of the wireless device 30) can be configured to itself transmit (e.g. via a communications interface 36 of the wireless device 30), or cause another entity to transmit, this information according to some embodiments.

Although also not illustrated in FIG. 4, in some embodiments, the method may comprise, if the wireless device 30 is authorised to join the cluster, connecting to a virtual private network (VPN) assigned to the master node 10. More specifically, the wireless device 30 (e.g. the processing circuitry 32 of the wireless device 30) can be configured to connect to this VPN according to some embodiments.

Although also not illustrated in FIG. 4, in some embodiments, the method may comprise receiving information about the master node 10 periodically or in response to a request for the information. More specifically, the wireless device 30 (e.g. the processing circuitry 32 of the wireless device 30) can be configured to receive (e.g. via a communications interface 36 of the wireless device 30) this information according to some embodiments. In some embodiments, the information about the master node 10 can comprise an identity of the master node 10 and/or an (e.g. IP or virtual IP) address of the master node 10. In some embodiments, information identifying the master node 10 may be set by the owner of the master node 10 and/or may be modifiable by the owner of the master node 10.

Although not illustrated in FIG. 4, in some embodiments, an address assigned to the wireless device 30 may be terminated when the wireless device 30 is unreachable within the network for a predefined amount of time. In other embodiments, the address assigned to the wireless device 30 may be stored when the wireless device 30 is unreachable within the network for a predefined amount of time for the address to be available for reassignment to the wireless device 30 when the wireless device 30 is reachable within the network.

In some embodiments, the master node 10 can be one of a plurality of master nodes and the cluster of worker nodes can be one of a plurality of clusters of worker nodes. In these embodiments, each cluster of worker nodes can be controllable by a respective master node 10. In some of these embodiments, the method may comprise automatically joining any cluster of worker nodes where the wireless device 30 is registered to an owner of that cluster of worker nodes and/or the respective master node 10. More specifically, the wireless device 30 (e.g. the processing circuitry 32 of the wireless device 30) can be configured to automatically join any cluster of worker nodes where this is the case.

According to some embodiments, any one or more of the worker nodes referred to herein can be a wireless device. Thus, according to some embodiments, any one or more of the worker nodes referred to herein can themselves be as described herein in relation to the wireless device 30. In some embodiments, the worker nodes referred to herein (which can comprise the wireless device 30 referred to herein once it joins the cluster) may be reachable by each other, such as through internet control message protocol (ICMP) ping requests. In some embodiments, such as those where the master node 10 is one of the worker nodes, the master node 10 referred to herein can be a wireless device. Thus, according to some embodiments (such as those where the entity is the node 20 that is separate from the master node 10 and worker nodes), the master node 10 referred to herein can itself be as described herein in relation to the wireless device 30.

Although not illustrated in FIG. 4, in some embodiments, the method may comprise checking the identity of the cluster of worker nodes and/or the (e.g. mobile) network serving the wireless device. More specifically, the processing circuitry 12, 22 of the entity 10, 20 may perform this check. In this way, it can be determined if the master node 10 or the wireless device 30 is an impersonator, such that appropriate action can be taken to avoid this.

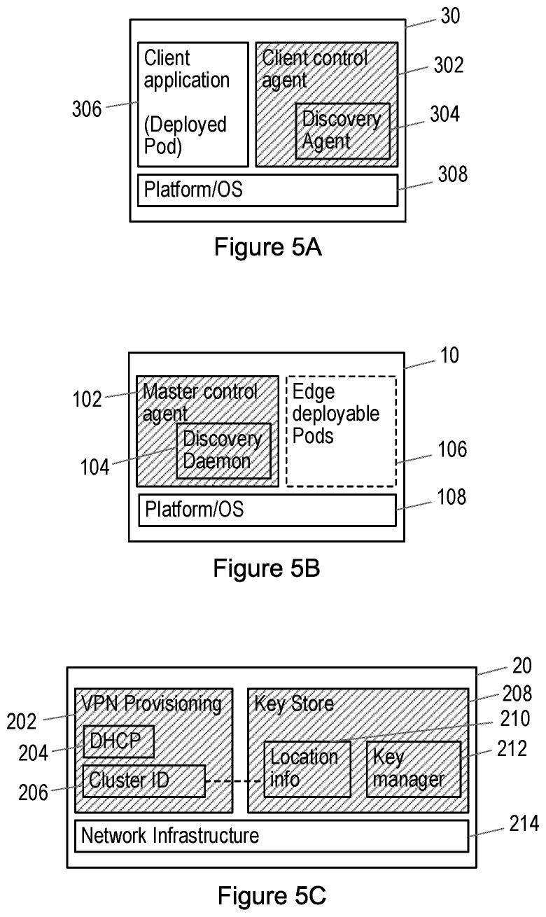

FIG. 5A illustrates a wireless device 30, or the prospective worker node, according to some embodiments. As illustrated in FIG. 5A, in some embodiments, one or more software agents 302, 304 can be deployed on the wireless device 30, such as a (client) control agent 302 and/or a discovery agent 304. In these embodiments, the software agents 302, 304 can comprise instructions (e.g. stored in the memory 34 of the wireless device 30) executable by the processing circuitry 32 of the wireless device 30 to cause the processing circuitry 32 of the wireless device 30 to perform the method described herein in respect of the wireless device 30.

In some embodiments, the discovery agent 304 can comprise instructions executable by the processing circuitry 32 of the wireless device 30 to cause the processing circuitry 32 of the wireless device 30 to perform the broadcasting of the second request, which is the request to discover a master node 10 to which the wireless device 30 is connectable. The control agent 302 may comprise instructions executable by the processing circuitry 32 of the wireless device 30 to cause the processing circuitry 32 of the wireless device 30 to perform all other parts of the method described herein in respect of the wireless device 30. In some embodiments, the control agent 102 may be deployed as a service of an operating system (OS), such as through systemd for Debian-based Linux distributions.

In some embodiments, an owner can have multiple clusters and worker nodes belonging (or registered) to the same owner can be physically deployed to any of those clusters, at any point in time. In some of these embodiments, where the wireless device 30 belongs (or is registered) to a cluster of worker nodes, the control agent 302 of the wireless device 30 may retain information about the wireless device 30 belonging (or being registered) to the cluster of worker nodes and, if this information turns out to be outdated (e.g. due to the wireless device 30 having been shifted to a different cluster of worker nodes), initiate a request for bootstrapping.

This bootstrapping process can involve the control agent 302 of the wireless device 30 first spawning (e.g. loading and executing) the discovery agent 304, which searches for the master node 10 of the cluster to which the wireless device 30 currently belongs (or is registered) by performing network discovery on the local network. After finding this master node 10, such as by having obtained its (e.g. IP or virtual IP) address and/or name, the control agent 302 of the wireless device 30 may request the correct authentication key from the entity 10, 20 and attempt to authenticate the wireless device 30 on the master node 10. If the authentication is successful, the control agent 302 of the wireless device 30 may then perform the steps to receive the required information from the master node 10 and execute this information (e.g. in case the information comprises commands, such as the join command) to connect to the master node 10. If this authentication process is successful, the wireless device 30 becomes a fully recognised worker node of the respective cluster of worker nodes. If the authentication process is unsuccessful, the authentication process may be restarted.

As illustrated in FIG. 5A, in some embodiments, the wireless device 30 may optionally also comprise one or more (client) applications 306 and/or a platform/OS 308. It will be appreciated that FIG. 5A only shows the components required to illustrate an embodiment of the wireless device 30 and, in practical implementations, the wireless device 30 may comprise additional or alternative components to those shown.

FIG. 5B illustrates a master node (e.g. device) 10 according to some embodiments. As illustrated in FIG. 5B, one or more software agents can be deployed on the master node 10, such as a (master) control agent 102. In these embodiments, the control agent 102 can comprise instructions (e.g. stored in the memory 14 of the master node 10) executable by the processing circuitry 12 of the master node 10 to cause the processing circuitry 12 of the master node 10 to perform the method described herein in respect of the master node 10. Thus, for example, the control agent 102 may control several (or all) parts of the method that relate to the interaction with the prospective worker node 30, e.g. in order to fulfil a successful bootstrapping process for the prospective worker node 30. In some embodiments, the control agent 102 may be deployed as a service of an OS, such as through systemd for Debian-based Linux distributions.

In some embodiments, the control agent 102 may spawn (e.g. load and execute) a program, which will be referred to as a discovery daemon 104, that is identifiable by worker nodes (e.g. in the local network, such as through a network discovery mechanism). In some embodiments, the control agent 102 may wait for connection requests from any prospective worker nodes 30 that find its (e.g. IP or virtual IP) address. In some embodiments, the control agent 102 may initiate a bootstrapping process only for prospective worker nodes 30 that have the correct public key, as described earlier. In some embodiments, the private key may be kept by the master node 10, or obtained from a node 20 (e.g. central controller) that is separate from the master node 10 and worker nodes prior to the initiation of the bootstrapping process. In some embodiments, a (e.g. properly configured) network slice may allow any (e.g. IP or virtual IP) address to be accepted.

As illustrated in FIG. 5B, in some embodiments, the master node 10 may optionally comprise one or more edge deployable software units (e.g. pods) 106 and/or a platform/OS 108. It will be appreciated that FIG. 5B only shows the components required to illustrate an embodiment of the master node 10 and, in practical implementations, the master node 10 may comprise additional or alternative components to those shown.

FIG. 5C illustrates a node 20 (e.g. central controller) that is separate from the master node 10 and worker nodes according to some embodiments. As illustrated in FIG. 5C, in some embodiments, a virtual private network (VPN) provisioning module 202 can be deployed on the node 20 that is separate from the master node 10 and worker nodes. For example, the memory 24 of the node 20 that is separate from the master node 10 and worker nodes can comprise the VPN provisioning module 202. In some of these embodiments, the VPN provisioning module 202 can store a protocol 204 used to assign any of the addresses referred to herein (e.g. a dynamic host configuration protocol, DHCP, used to assign any of the IP addresses referred to herein) and one or more identifiers 206 that each identify a cluster of worker nodes (namely, one or more cluster IDs). As also illustrated in FIG. 5C, a key store 208 can be deployed on the node 20 that is separate from the master node 10 and worker nodes. For example, the memory 24 of the node 20 that is separate from the master node 10 and worker nodes can comprise the key store 208. In some of these embodiments, the key store 208 can store any of the location information 210 referred to herein and/or a key manager 212. The key manager 212 can store any of the (public and/or private) keys referred to herein.

Thus, in some embodiments, the node 20 (e.g. central controller) that is separate from the master node 10 and worker nodes can manage the provision of keys to the corresponding entities as described herein (e.g. the private key to the master node 10 or the control agent 102 of the master node 10, and public key to the prospective worker node 30 or the control agent 302 of the prospective worker node 30). In some embodiments, the key provisioning referred to herein may occur only after an explicit request from a worker node has been issued. In some embodiments, the communication involved in the key provisioning referred to herein may occur through REST APIs that can implement specific requests and/or responses. However, in other embodiments, a mobile core network may provide the key provision management as a service to the cluster (or all clusters) of worker nodes.

As illustrated in FIG. 5C, in some embodiments, the node 20 (e.g. central controller) that is separate from the master node 10 and worker nodes may comprise a network infrastructure 214. It will be appreciated that FIG. 5C only shows the components required to illustrate an embodiment of the node 20 that is separate from the master node 10 and worker nodes and, in practical implementations, the node 20 that is separate from the master node 10 and worker nodes may comprise additional or alternative components to those shown.

There is further provided a method performed by a system. The method performed by the system comprises the method described herein with respect to the entity 10, 20 and the method described herein with respect to the wireless device. There is also provided a system comprising the entity 10, 20 as described herein and the wireless device 30 as described herein.

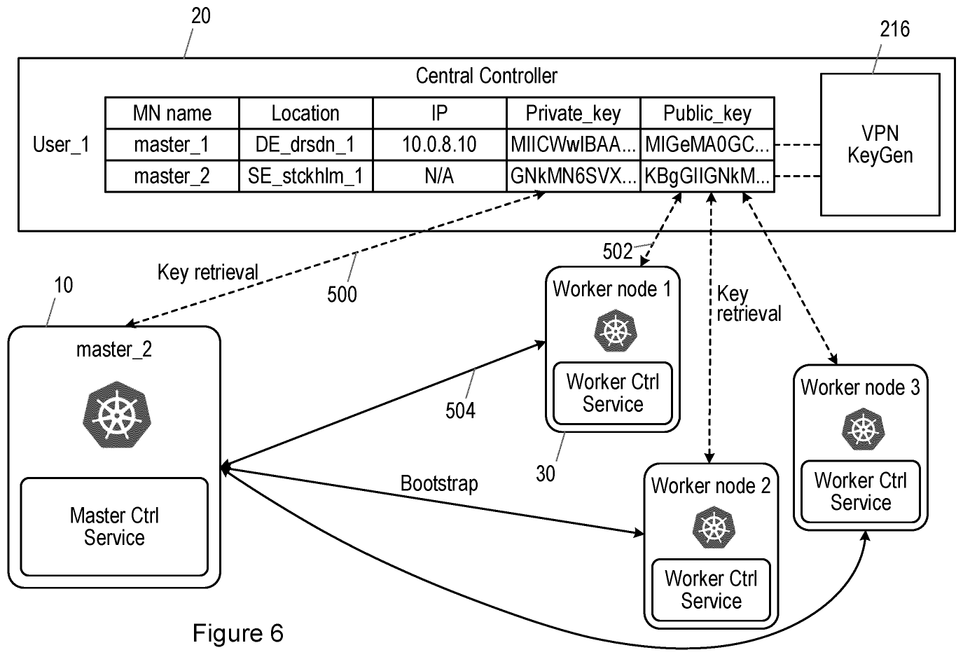

FIG. 6 illustrates a method performed by a system according to an embodiment. The method is for the exchange of keys, which may be used in embodiments described herein that involve such keys. The system illustrated in FIG. 6 comprises a master node 10 (which can be referred to as “master_2”), a wireless device 30 (which is a prospective worker node and can thus be referred to as “Worker node 1”), and a node 20 (which can be referred to as a “Central Controller”) that is separate from the master node 10 and worker nodes. As illustrated in FIG. 6, the wireless device 30 may be a prospective worker node of a cluster of worker nodes (“Worker node 2”, “Worker node 3”, etc.), which are controllable by the master node 10.

As illustrated in FIG. 6, the node 20 that is separate from the master node 10 and worker nodes can store information about one or more master nodes (“master_1”, “master_2”, etc.). For example, the information about each master node can comprise a name of the master node, a location of the master node, an (e.g. IP or virtual IP) address of the master node, a private key associated with the master node 10, and a public key corresponding to the private key. As illustrated in FIG. 6, in some embodiments, the node 20 that is separate from the master node 10 and worker nodes may comprise a (e.g. VPN) key generator 216. The key generator 216 may be responsible for generating the public key and/or the private key according to some embodiments.

As illustrated in FIG. 6, in some embodiments, the master node 10 can comprise a master control service. The master control service can be as described earlier with reference to the processing circuitry 12 of the master node 10 and/or the control agent 102 of the master node 10. As also illustrated in FIG. 6, in some embodiments, the wireless device can comprise a worker control service. The worker control service can be as described earlier with reference to the processing circuitry 32 of the wireless device 30 and/or the control agent 302 of the wireless device 30.

As illustrated by arrow 500 of FIG. 6, the master node 10 can acquire (e.g. request and receive) its private key (e.g. “GNkMN6SVX . . . ”) from the node 20 that is separate from the master node 10 and worker nodes. As illustrated by arrow 502 of FIG. 6, the wireless device 30 can acquire (e.g. request and receive) the corresponding public key (e.g. “KBgGIIGNKM . . . ”) from the node 20 that is separate from the master node 10 and worker nodes.

As described earlier, in some embodiments the wireless device 30 may be authorised to join the cluster of worker nodes if the wireless device 30 has the public key that corresponds to the private key of the master node 10. As illustrated by arrow 504 of FIG. 6, a bootstrapping process may be performed. For example, if the wireless device 30 is authorised to join the cluster, the master node 10 may transmit information towards the wireless device 30, where the information is that which is necessary for the wireless device 30 to connect to the master node 10, such as an (e.g. IP or virtual IP) address for the master node 10. The information transmitted towards the wireless device 30 allows the wireless device 30 to connect to the master node 10 and thus the wireless device 30 may then join the cluster of worker nodes by connecting to the master node 10.

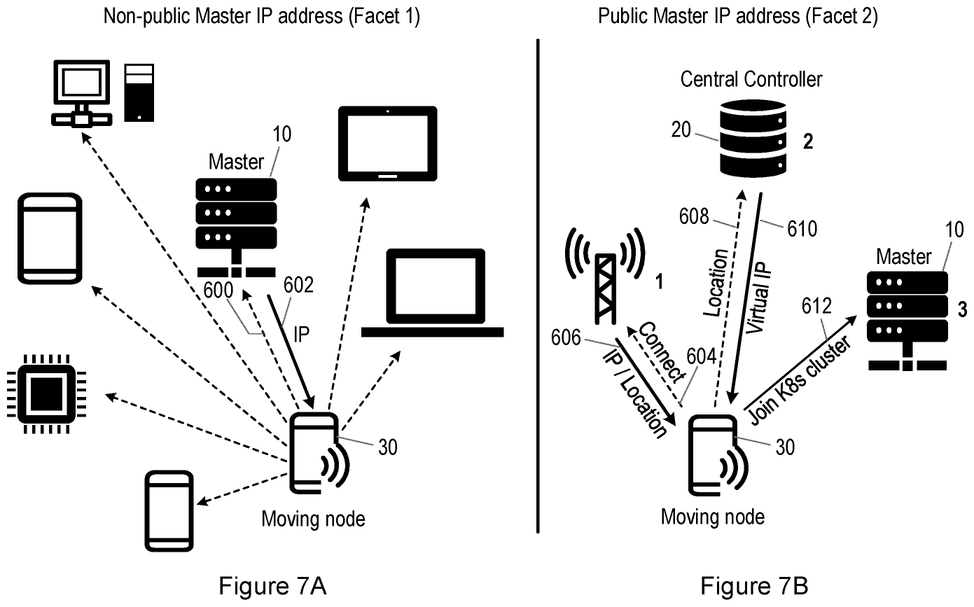

FIG. 7A illustrates a method performed by a system according to an embodiment. The method allows a wireless device to easily perform the task of finding a master node 10. The system illustrated in FIG. 7A comprises the master node 10 (which can be referred to as “Master”) and the wireless device 30 (which can be moving and thus can be referred to as “Moving node”). Although not illustrated in FIG. 7A, the system may comprise a node that is separate from the master node 10 and the worker nodes. This separate node may, for example, store the name of the master node 10 (and optionally other master nodes, e.g. belonging to the same owner) and optionally respective private and/or public keys. Although also not illustrated in FIG. 7A, the system may comprise a cluster of worker nodes that are controllable by the master node 10.

In the embodiment illustrated in FIG. 7A, all nodes, devices and/or entities may be located (or reside) in the same network space (e.g. on the same premises), such as the same local area network (LAN). In some embodiments, the network space can be WiFi-based, e.g. where a DHCP may be handled by the local network and private (e.g. IP or virtual IP) addresses are typically used. In some embodiments, the nodes, devices and/or entities may each be assigned (e.g. by a local DHCP, such as those available in most common routers) an internally defined static IP address. In some embodiments, the nodes, devices and/or entities may be able to reach each other, such as through internet control message protocol (ICMP) ping requests.

As illustrated by the dashed arrows of FIG. 7A, in some embodiments, the wireless device 30 may broadcast a request to discover a master node to which the wireless device 30 is connectable. Herein, this request is referred to as “a second request”. As illustrated by arrow 600 of FIG. 7A, the master node 10 may receive the broadcast second request. The second request may indicate that the wireless device 30 wishes to join, as a worker node, the cluster of worker nodes that are controllable by the master node 10.

As illustrated by arrow 602 of FIG. 7A, if the wireless device 30 is authorised to join the cluster, the master node 10 may transmit information towards the wireless device 30, where the information is that which is necessary for the wireless device 30 to connect to the master node 10, such as an (e.g. IP or virtual IP) address for the master node 10. The information transmitted towards the wireless device 30 allow the wireless device 30 to connect to the master node 10 and thus the wireless device 30 may then join the cluster of worker nodes by connecting to the master node 10.

In some embodiments, a control agent 102 may be installed in the master node 10 to spawn a discovery daemon 104 (as described earlier with reference to FIG. 5B). In these embodiments, the discovery daemon 104 can attend to any discovery requests 600 from prospective worker nodes, such as the wireless device 30. In turn, in some embodiments, a control agent 302 may be installed in the prospective worker nodes, such as the wireless device 30, to spawn a discovery agent 304 (as described earlier with reference to FIG. 5A). In these embodiments, the discovery agent 304 can perform such discovery requests, e.g. until the information mentioned earlier is received from the control agent 102 of the master node 10.

The embodiment illustrated in FIG. 7A may be particularly valuable where the cluster of worker nodes is to be kept local and is not meant to be reachable through a public (e.g. IP or virtual IP) address, such as where the owner of the cluster has no intention of making the cluster publicly reachable.

FIG. 7B illustrates a method performed by a system according to an embodiment. The system illustrated in FIG. 7B comprises a master node 10 (which can be referred to as “Master”), a node 20 (which can be referred to as a “Central Controller”) that is separate from the master node 10, and a wireless device 30 (which can be moving and thus can be referred to as “Moving node”). Although not illustrated in FIG. 7B, the system may comprise a cluster of worker nodes that are controllable by the master node 10.

The method performed by the system illustrated in FIG. 7B is aimed at tackling an issue with the reachability of a master node 10. For example, the master node 10 may be located in a different network space from the wireless device 30 or at a different location from the wireless device 30 (e.g. the master node 10 may not reside within the industrial premises or any other premises in which the wireless device 30 is located), or the worker nodes may be connected through a mobile cellular network. In some embodiments, the master node 10 may be a remote virtual machine (VM) instance, e.g. spawned through a cloud platform, web services, or similar. In these situations, the node 20 that is separate from the master node 10 may be responsible for publishing an (e.g. IP or virtual IP) address of the master node 10. In some embodiments, the network space may rely on cellular networks or WiFi. For cellular networks, at least a fourth generation long term evolution (4G-LTE) connection may be used. In some embodiments, a fifth generation (5G) connection may be used, such as for latency-critical implementations and precise location information.

Although the master node 10 need not be physically present in the same network space (e.g. at the same premises) as the wireless device 30, it may be reachable by the wireless device 30. For example, it may be reachable through a private network (e.g. virtual private network, VPN) overlay. This overlay may be provided by the node 20 that is separate from the master node 10 according to some embodiments. The overlay can solve the reachability problem that typically occurs in cellular networks, where the connecting devices are hidden behind network address translation (NAT). If the master node 10 is remote from the wireless device 30, the wireless device 30 needs to be aware of its own location, such as through network provided location information (NPLI), e.g. especially if using 5G. The location of the wireless device 30 is information that can be used to select the appropriate master node 10, such as from a memory 24 of the node 20 that is separate from the master node 10. In some embodiments, the nodes, devices and/or entities may be able to reach each other, such as through internet control message protocol (ICMP) ping requests. Moreover, it can be guaranteed that the nodes, devices, and/or entities are able to reach each other within the private network (e.g. VPN) overlay according to some embodiments.

As illustrated by arrow 604 of FIG. 7B, the wireless device 30 may transmit a request towards (e.g. a network node, such as a base station of) the network that is serving the wireless device 30. The request can be a request for the wireless device 30 to connect to the master node 10. For example, the request can comprise a request for the wireless device 30 to acquire mobile data connectivity, e.g. through an antenna of an internet service provider (ISP) by the wireless device 30 connecting to that antenna. As illustrated by arrow 606 of FIG. 7B, in response to the request, the wireless device 30 may receive location information from (e.g. the network node, such as the base station of) the network, which is indicative of the location of the wireless device 30, and/or the (e.g. IP or virtual IP) address of the wireless device 30. The (e.g. network node, such as the base station of the) network may retrieve the location information by, for example, identifying the network served by a currently connected antenna or by identifying a specific network slice.

As illustrated by arrow 608 of FIG. 7B, in some embodiments, the wireless device 30 may transmit the location information towards the node 20 that is separate from the master node 10 and thus this node 20 can receive the location information from the wireless device 30. Although not illustrated in FIG. 7B, the node 20 that is separate from the master node 10 can use the location information received from the wireless device 30 to identify, from a plurality of master nodes and their respective locations, a master node 10 to which the wireless device 30 can connect. For example, the location of the wireless device 30 can be associated with the location registered for this identified master node 10. Here, the term “location” does not necessarily mean a specific geographical placement and can instead be understood to mean the network to which the wireless device 30 is connected.

Although also not illustrated in FIG. 7B, in some embodiments, the node 20 that is separate from the master node 10 may attach the wireless device 30 to a specific private network (e.g. VPN) overlay assigned to the identified master node 10. This overlay can allow the wireless device 30 to be in the same network space as the identified master node 10. There may, for example, be a different private network (e.g. VPN) overlay assigned to each master node. In this way, each master node can have its own dedicated private network (e.g. VPN). The private network (e.g. VPN) overlay assigned to each master node 10 may be created at the time that master node is registered, e.g. at the node 20 that is separate from the master node 10.

As illustrated by arrow 610 of FIG. 7B, if the wireless device 30 is authorised to join the cluster of worker nodes that are controllable by the identified master node 10, the node 20 that is separate from the master node 10 may transmit an (e.g. IP or virtual IP) address for the master node 10 towards the wireless device 30 and thus the wireless device 30 receives the address for the master node 10. The address for the master node 10 may be among the data stored for the master node 10 at the node 20 that is separate from the master node 10. Thus, the wireless device 30 can retrieve the address for the relevant master node 10 directly through the node 20 that is separate from the master node 10 according to some embodiments. The address for the master node 10 allows the wireless device 30 to connect to the master node 10.

As illustrated by arrow 612 of FIG. 7B, in some embodiments, the wireless device 30 may join the cluster by connecting to the master node 10. Thus, the bootstrapping process described earlier can be performed.

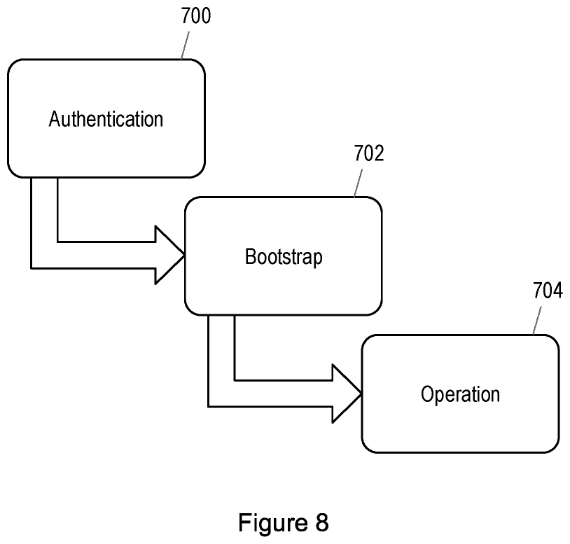

FIG. 8 illustrates a method performed by a system according to an embodiment. At block 700 of FIG. 8, a wireless device 30 tries to connect (e.g. subscribe) to a master node 10 and the entity 10, 20 determines if the wireless device 30 is authorised to join a cluster of worker nodes controllable by the master node 10. At block 702 of FIG. 8, there may be an exchange of configuration information from the entity 10, 20 to the wireless device 30. For example, in some embodiments, if the wireless device 30 is authorised to join the cluster, the entity 10, 20 initiates transmission of an (e.g. IP or virtual IP) address for the master node 10 towards the wireless device 30 to allow the wireless device 30 to connect to the master node 10. At block 704 of FIG. 8, the wireless device 30 is ready to participate in the cluster. Thus, the wireless device 30 (e.g. together with the other worker nodes of the cluster) operates to provide a computational resource in a network.

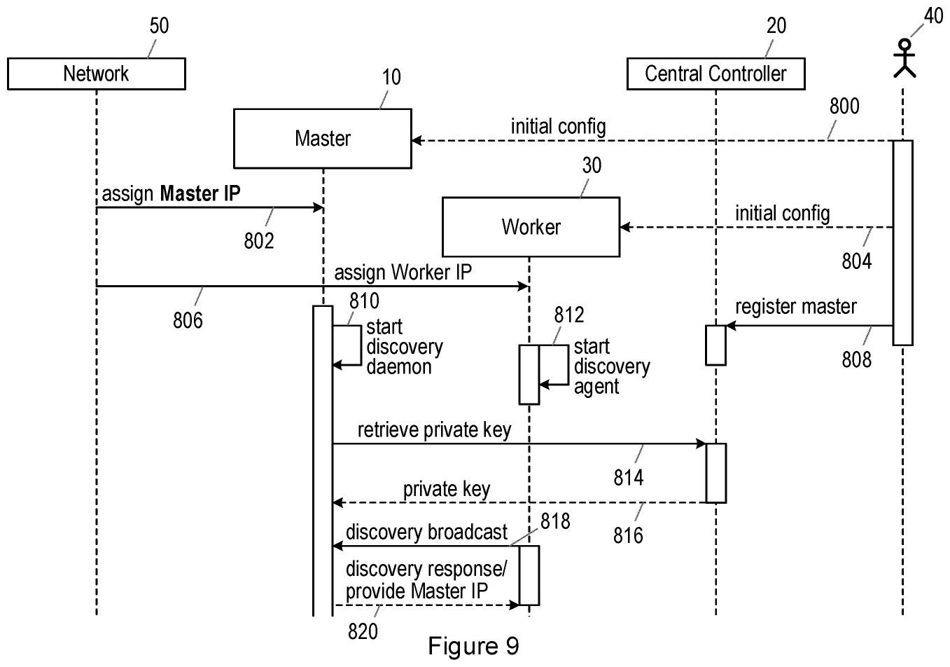

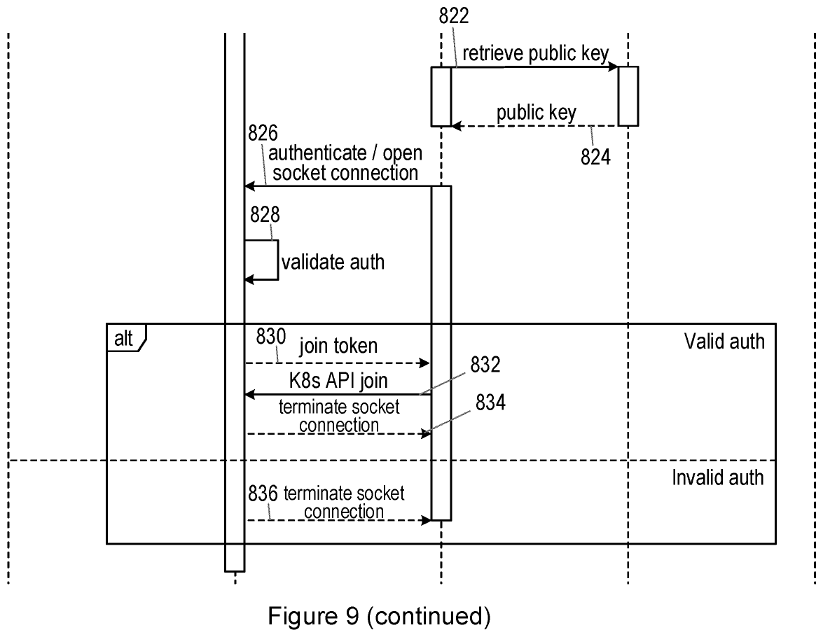

FIG. 9 is a signalling diagram illustrating an exchange of signals in a system according to an embodiment. The system illustrated in FIG. 9 comprises a master node 10 (which can be referred to as “Master”), a node 20 (which can be referred to as “Central Controller”) that is separate from the master node 10, and a wireless device 30 (which is a prospective worker node so can be referred to as “Worker”). Although not illustrated in FIG. 9, the system may also comprise a cluster of worker nodes, which are controllable by the master node 10. There is also illustrated in FIG. 9 an owner 40 (of the master node 10, the wireless device, and/or worker nodes) and a network 50. The worker nodes are responsible for providing a computational resource in the network 50.

As illustrated by arrow 800 of FIG. 9, in some embodiments, the master node 10 may initially be configured by the owner 40 of the master node 10. Although not illustrated in FIG. 9, in some embodiments, the network 50 (e.g. a network node, such as a base station, of the network 50) can assign an address (e.g. an IP address or virtual IP address) to the master node 10. As illustrated by arrow 802 of FIG. 9, in some embodiments, the network 50 (e.g. the network node, such as the base station, of the network 50) can transmit the assigned address towards the master node 10 and thus the master node 10 can receive the address that is assigned to it.

As illustrated by arrow 804 of FIG. 9, the wireless device 30 may initially be configured by the owner 40 of the wireless device 30. Although not illustrated in FIG. 9, in some embodiments, the network 50 (e.g. a network node, such as a base station, of the network 50) can assign an address (e.g. an IP address or virtual IP address) to the wireless device 30. As illustrated by arrow 806 of FIG. 9, in some embodiments, the network 50 (e.g. the network node, such as the base station, of the network 50) may transmit the assigned address towards the wireless device 30 and thus the wireless device 30 can receive the address that is assigned to it.

As illustrated by arrow 808 of FIG. 9, the owner 40 of the master node 10 may register the master node 10 with the node 20 that is separate from the master node 10. In some embodiments, the registration of the master node 10 can comprise storing information about the master node 10 at the node 20 that is separate from the master node 10. In some embodiments, the information about the master node 10 can comprise an identity (ID) of the master node 10 (such as a name of the master node 10), a location of the master node 10, an (e.g. IP or virtual IP) address of the master node 10, a private key associated with the master node 10, and/or a public key corresponding to the private key. In some embodiments, the stored information about the master node 10 can be modifiable by the owner 40 of the master node 10. For example, the owner 40 of the master node 10 may, e.g. at any time, update or remove the stored information about the master node 10.

As illustrated by arrow 810 of FIG. 9, the master node 10 can start a program, namely the discovery daemon 104 (as described earlier with reference to FIG. 5B). The discovery daemon 104 can attend to any discovery requests from prospective worker nodes, such as the wireless device 30. As illustrated by arrow 812 of FIG. 9, the wireless device 30 can start a program, namely the discovery agent 304 (as described earlier with reference to FIG. 5A). In these embodiments, the discovery agent 304 can perform discovery requests.

As illustrated by arrow 814 of FIG. 9, in some embodiments, the master node 10 may transmit a request for a private key towards the node 20 that is separate from the master node 10 and worker nodes. Thus, the node 20 that is separate from the master node 10 and worker nodes receives the request. The private key is part of a public/private key pair and thus there is a public key that corresponds to the private key. As illustrated by arrow 816 of FIG. 9, the master node 10 may receive a response to the request for a private key from the node 20 that is separate from the master node 10 and worker nodes. The response comprises the private key. Although not illustrated in FIG. 9, in other embodiments, the private key may already be stored in a memory 14 of the master node 10 and thus the private key may be acquired from this memory.

As illustrated by arrow 818 of FIG. 9, in some embodiments, the wireless device 30 may broadcast a request to discover a master node 10 to which the wireless device 30 is connectable, and the master node 10 may receive the broadcast request. As illustrated by arrow 820 of FIG. 9, in some embodiments, the master node 10 may transmit a response towards the wireless device 30. In some embodiments, this response can comprise the (e.g. IP or virtual IP) address for the master node 10.

As illustrated by arrow 822 of FIG. 9, the wireless device 30 may transmit a request for the public key (which corresponds to the private key of the master node 10) towards the node 20 that is separate from the master node 10 and thus this node 20 may receive this request from the wireless device 30. As illustrated by arrow 824 of FIG. 9, in response to this request, the node 20 that is separate from the master node 10 can transmit the public key towards the wireless device 30 and thus the wireless device 30 can receive the public key.

As illustrated by arrow 826 of FIG. 9, the wireless device 30 may transmit a request towards the master node 10, which is a request for the wireless device 30 to connect to the master node 10 (e.g. via a socket connection or any other connection), and thus the master node 10 can receive this request from the wireless device 30. As illustrated by arrow 828 of FIG. 9, the master node 10 may determine if the wireless device 30 is authorised to join the cluster of worker nodes that are controllable by the master node 10. The master node 10 automatically allows the wireless device 30 to join the cluster as a worker node if the wireless device 30 is authorised to join the cluster. The wireless device 30 is authorised to join the cluster if the wireless device 30 is registered to an owner of the master node 10 and/or cluster of worker nodes. In the embodiments illustrated in FIG. 9, the wireless device 30 is authorised to join the cluster if the wireless device 30 has the public key that corresponds to the private key of the master node 10.

As illustrated by arrow 830 of FIG. 9, in some embodiments, if the wireless device 30 is authorised to join the cluster, the master node 10 may transmit, towards the wireless device 30, information (e.g. a token) that is necessary for the wireless device 30 to join the cluster. Thus, the wireless device 30 can use this information to join the cluster. As illustrated by arrow 832 of FIG. 9, in some embodiments, the wireless device 30 may transmit a request to join the cluster towards the master node 10. As illustrated by arrow 834 of FIG. 9, in some embodiments, the master node 10 may terminate the connection it has with the wireless device 30, such as when the wireless device 30 leaves the cluster.

On the other hand, if the wireless device 30 is not authorised to join the cluster (e.g. due to the wireless device 30 not having the public key that corresponds to the private key of the master node 10), the master node 10 may automatically disallow the wireless device 30 from joining the cluster as a worker node. As illustrated by arrow 836 of FIG. 9, in some embodiments, the master node 10 may then terminate the connection it has with the wireless device 30.

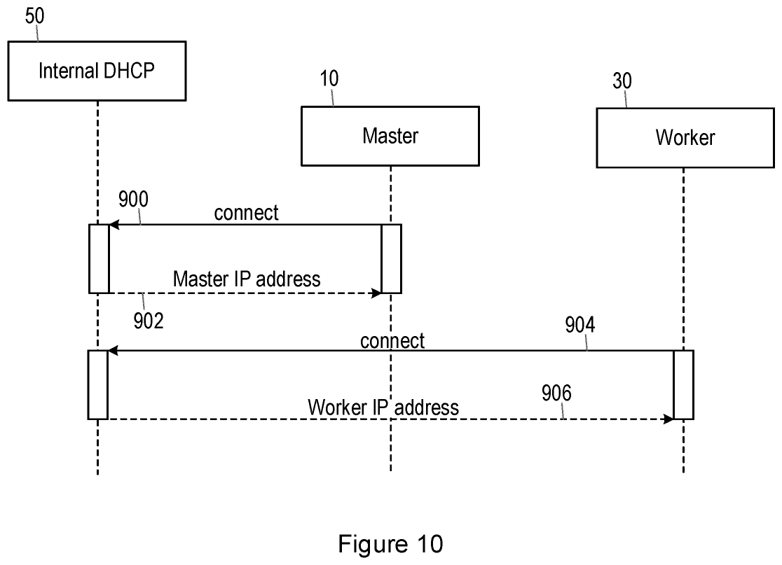

FIG. 10 is a signalling diagram illustrating an exchange of signals in a system according to an embodiment. The system illustrated in FIG. 10 comprises a master node 10 (which can be referred to as “Master”) and a wireless device 30 (which is a prospective worker node so can be referred to as “Worker”). Although not illustrated in FIG. 10, the system may also comprise a cluster of worker nodes, which are controllable by the master node 10. A network 50 is also illustrated in FIG. 10. In the embodiment illustrated in FIG. 10, the network 50 is a local network. In some embodiments, the network 50 may be a Wi-Fi based network, such as a local area network (LAN). The network 50 may handle one or more internal protocols, such as an internal dynamic host configuration protocol (DHCP).

As illustrated by arrow 900 of FIG. 10, in some embodiments, the master node 10 may transmit a connection request towards the network 50 (e.g. a network node, such as a base station, of the network 50). In some embodiments, the connection request can be a request for the master node 10 to connect to the network. Although not illustrated in FIG. 10, in some embodiments, the network 50 (e.g. the network node, such as the base station, of the network 50) can assign an (e.g. IP or virtual IP) address to the master node 10. As illustrated by arrow 902 of FIG. 10, in some embodiments, the network node 50 (e.g. the network node, such as the base station, of the network 50) may transmit the address assigned to the master node 10 towards the master node 10 and thus the master node 10 can receive this address.

As illustrated by arrow 904 of FIG. 10, in some embodiments, the wireless device 30 may transmit a connection request towards the network 50 (e.g. a network node, such as a base station, of the network 50). In some embodiments, the connection request can be a request for the wireless device 30 to connect to the network 50. Although not illustrated in FIG. 10, in some embodiments, the network 50 (e.g. the network node, such as the base station, of the network 50) can assign an (e.g. IP or virtual IP) address to the wireless device 30. As illustrated by arrow 906 of FIG. 10, in some embodiments, the network node 50 (e.g. the network node, such as the base station, of the network 50) may transmit the address assigned to the wireless device 30 towards the wireless device 30 and thus the wireless device 30 can receive this address.

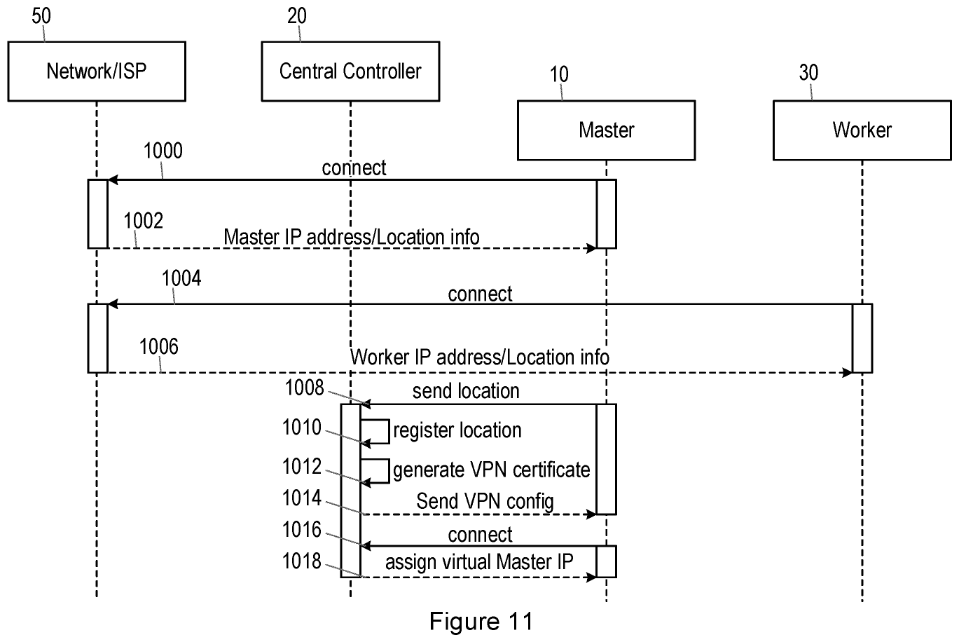

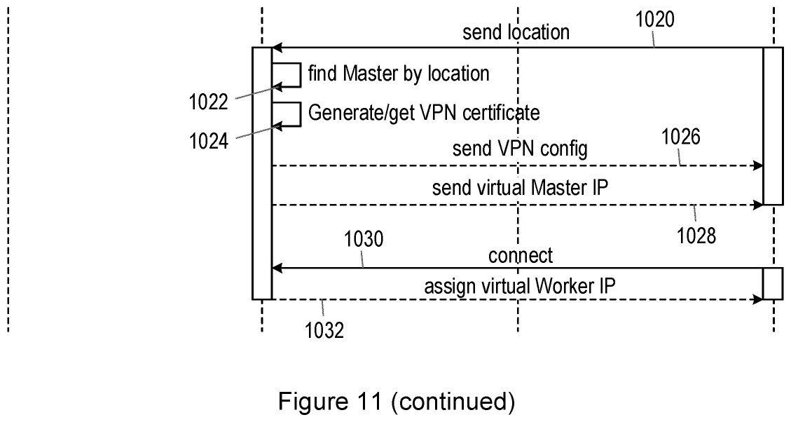

FIG. 11 is a signalling diagram illustrating an exchange of signals in a system according to an embodiment. The system illustrated in FIG. 11 comprises a master node 10 (which can be referred to as “Master”), a node 20 (which can be referred to as “Central Controller”) that is separate from the master node 10, and a wireless device 30 (which is a prospective worker node so can be referred to as “Worker”). Although not illustrated in FIG. 11, the system may also comprise a cluster of worker nodes, which are controllable by the master node 10. There is also illustrated in FIG. 11 an owner 40 (of the master node 10, the wireless device, and/or worker nodes) and a network 50. The worker nodes are responsible for providing a computational resource in the network 50.

As illustrated by arrow 1000 of FIG. 11, in some embodiments, the master node 10 may transmit a connection request towards the network 50 (e.g. a network node, such as a base station, of the network 50). In some embodiments, the connection request can be a request for the master node 10 to connect to the network 50. Although not illustrated in FIG. 11, in some embodiments, the network 50 (e.g. the network node, such as the base station, of the network 50) can assign an (e.g. IP) address to the master node 10. As illustrated by arrow 1002 of FIG. 11, in some embodiments, the network node 50 (e.g. the network node, such as the base station, of the network 50) may transmit the address assigned to the master node 10 towards the master node 10 and thus the master node 10 may receive this address. As also illustrated by arrow 1002 of FIG. 11, in some embodiments, the network node 50 (e.g. the network node, such as the base station, of the network 50) may transmit information indicative of a location of the master node 10 towards the master node 10 and thus the master node 10 may receive this location information.

As illustrated by arrow 1004 of FIG. 11, in some embodiments, the wireless device 30 may transmit a connection request towards the network 50 (e.g. a network node, such as a base station, of the network 50). In some embodiments, the connection request can be a request for the wireless device 30 to connect to the network 50. Although not illustrated in FIG. 11, in some embodiments, the network 50 (e.g. the network node, such as the base station, of the network 50) can assign an (e.g. IP) address to the wireless device 30. As illustrated by arrow 1006 of FIG. 11, in some embodiments, the network node 50 (e.g. the network node, such as the base station, of the network 50) may transmit the address assigned to the wireless device 30 towards the wireless device 30 and thus the wireless device 30 may receive this address. As also illustrated by arrow 1006 of FIG. 11, in some embodiments, the network node 50 (e.g. the network node, such as the base station, of the network 50) may transmit information indicative of a location of the wireless device 30 towards the wireless device 30 and thus the wireless device 30 may receive this location information.

As illustrated by arrow 1008 of FIG. 11, in some embodiments, the master node 10 may transmit the information indicative of the location of the master node 10 towards the node 20 that is separate from the master node 10 and thus this node 20 may receive this information. As illustrated by arrow 1010 of FIG. 11, in some embodiments, the node 20 that is separate from the master node 10 may register (e.g. store, such as in a memory 22) the information indicative of the location of the master node 10. As illustrated by arrow 1012 of FIG. 11, in some embodiments, the node 20 that is separate from the master node 10 may assign a virtual private network (VPN) to the master node 10. This may comprise, for example, generating a VPN certificate for the master node 10. As illustrated by arrow 1014 of FIG. 11, in some embodiments, the node 20 that is separate from the master node 10 may transmit information indicative of the VPN assigned to the master node 10 towards the master node 10 and thus the master node 10 can receive this information.

As illustrated by arrow 1016 of FIG. 11, in some embodiments, the master node 10 can transmit a connection request towards the node 20 that is separate from the master node 10. The connection request can be a request for the master node 10 to connect to the node 20 that is separate from the master node 10. As illustrated by arrow 1018 of FIG. 11, in some embodiments, the node 20 that is separate from the master node 10 may assign a virtual (e.g. IP) address to the master node 10 and transmit this virtual address to the master node 10, such that the master node 10 receives it.

As illustrated by arrow 1020 of FIG. 11, in some embodiments, the wireless device 30 may transmit the information indicative of the location of the wireless device 30 towards the node 20 that is separate from the master node 10 and thus this node 20 can receive this information. As illustrated by arrow 1022 of FIG. 11, the node 20 that is separate from the master node 10 can identify, from a plurality of master nodes, a suitable master node 10 to which the wireless device 30 can connect. In some embodiments, the suitable master node 10 can be identified based on the location of the wireless device 30 and a location of each of the plurality of master nodes. For example, in some embodiments, the master node 10 identified from the plurality of master nodes may be the master node 10 that is in the same geographical area (e.g. the same building and/or premises) as the wireless device 30 and/or the same part (e.g. the same cell) of the network as the wireless device 30.

As illustrated by arrow 1024 of FIG. 11, in some embodiments, if the wireless device 30 is authorised to join the cluster of worker nodes that are controllable by the master node 10, the node 20 that is separate from the master node 10 may connect the wireless device 30 to the VPN assigned to the master node 10. The wireless device 30 is authorised to join the cluster if the wireless device 30 is registered to an owner of the master node 10 and/or cluster. As illustrated by arrow 1026 of FIG. 11, in some embodiments, if the wireless device 30 is authorised to join the cluster, the node 20 that is separate from the master node 10 may transmit information indicative of the VPN assigned to the master node 10 towards the wireless device 30 and thus the wireless device 30 can receive this information. As illustrated by arrow 1028 of FIG. 11, in some embodiments, the node 20 that is separate from the master node 10 may transmit the virtual (e.g. IP) address assigned to the master node 10 towards the wireless device 30 and thus the wireless device 30 receives this virtual address.

As illustrated by arrow 1030 of FIG. 11, in some embodiments, the wireless device 30 may transmit a connection request towards the node 20 that is separate from the master node 10 and thus this node 20 can receive the connection request from the wireless device 30. The connection request can be a request for the wireless device 30 to connect to the master node 10. As illustrated by arrow 1032 of FIG. 11, the node 20 that is separate from the master node 10 may assign a virtual (e.g. IP) address towards the wireless device 30 and transmit this virtual address towards the wireless device 30, such that the wireless device 30 receives it.

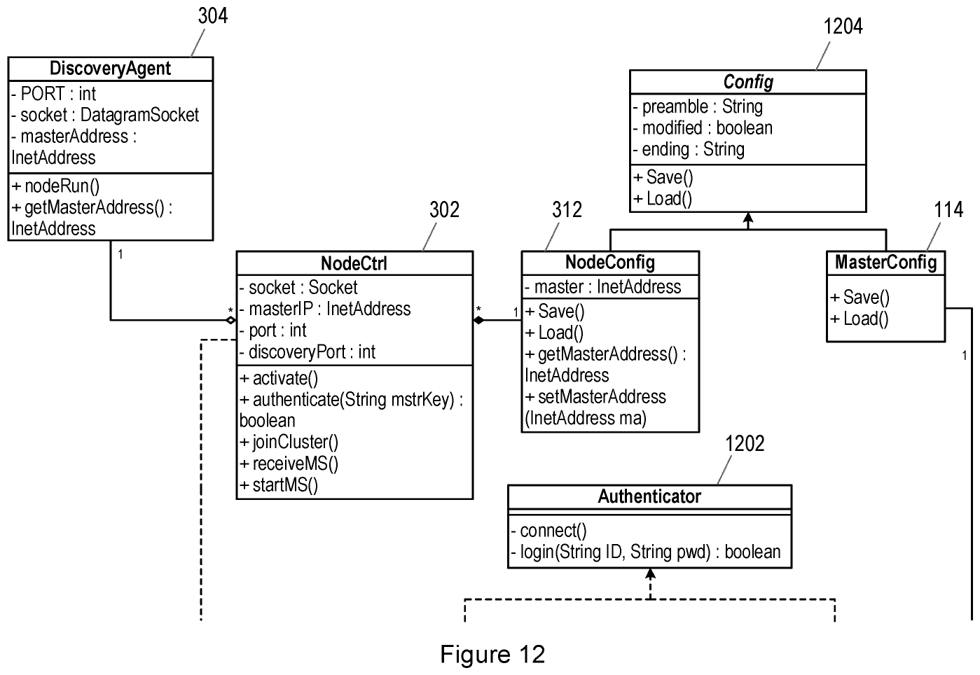

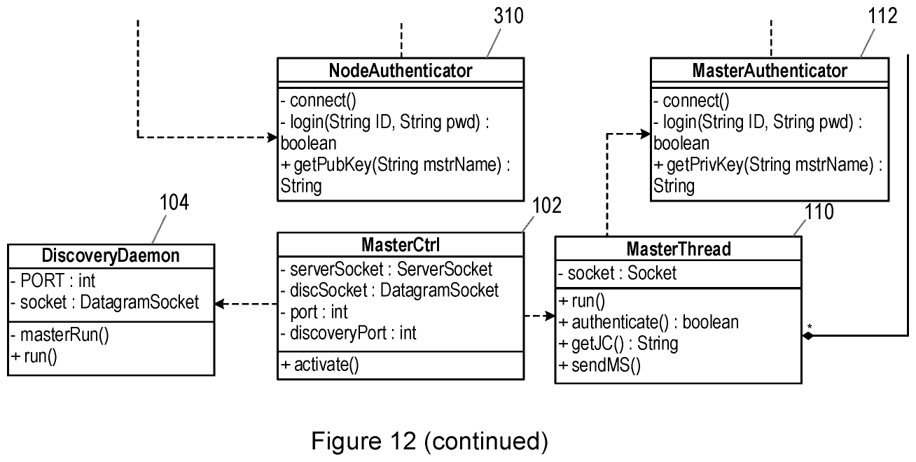

FIG. 12 illustrates a control architecture according to an embodiment. In more detail, FIG. 12 is a class diagram that represents some example components and functionalities (e.g. connect ( ) authenticate ( ) etc.) that can be used to fulfil the behaviour desired from the architecture of the control agents 102, 302 of both the master node 10 and worker nodes (such as the prospective worker node 30 and/or any one or more other worker nodes). The control agents 102, 302 allow the operation from the perspective of the master node 10 and worker nodes.

As illustrated in FIG. 12, the control agent 102 of the master node 10 (which is referred to in FIG. 12 as “MasterCtrl”) can have a dependency on four components, namely the discovery daemon 104 described earlier, one or more threads 110 to handle incoming connections from the wireless device 30 (and any one or more other wireless devices) as a prospective worker node, an authenticator component 112 to handle the retrieval of the private key from the node 20 that is separate to the master node 10 and worker nodes (e.g. the central controller, which is not illustrated in FIG. 12) and the verification of the wireless device 30, and a configuration manager 114 to preserve the configuration of the master node 10 (e.g. as defined by the owner 40, which is not illustrated in FIG. 12). It will be appreciated that FIG. 12 only illustrates an example of the components on which the control agent 102 of the master node 10 may have a dependency and, in practical implementations, the control agent 102 of the master node 10 may have a dependency on additional or alternative components to those shown.

As also illustrated in FIG. 12, the control agent 302 of the wireless device 30 (i.e. the prospective worker node, which is referred to in FIG. 12 as “NodeCtrl”) can have a dependency on three components, namely the discovery agent 304 described earlier, an authenticator component 310 to handle the retrieval of the public key from the node 20 that is separate to the master node 10 and worker nodes (e.g. the central controller, which is not illustrated in FIG. 12) and the identity verification with the master node 10, and a configuration manager 312 to preserve the configuration of a worker node (e.g. as defined by the owner 40, which is not illustrated in FIG. 12). It will be appreciated that FIG. 12 only illustrates an example of the components on which the control agent 302 of the wireless device 30 may have a dependency and, in practical implementations, the control agent 302 of the wireless device 30 may have a dependency on additional or alternative components to those shown.

As illustrated in FIG. 12, in some embodiments, there may be a common authenticator component 1202, which is an interface that can be used to define the minimum functionality that derived classes are to fulfil. As also illustrated in FIG. 12, in some embodiments, there may be a common configuration manager 1204, which is an abstraction used to define the structure that the derived classes are to fulfil. The derived classes can, for example, be any one or more of the authenticator component 112 on which the control agent 102 of the master node 10 depends, the configuration manager 114 on which the control agent 102 of the master node 10 depends, the authenticator component 310 on which the control agent 302 of the wireless device 30 depends, and the configuration manager 312 on which the control agent 302 of the wireless device 30 depends. FIG. 12 also illustrates some additional information that can be useful where the wireless device 30 moves from one cluster of worker nodes to another (i.e. between cluster transitions).

There is also provided a computer program comprising instructions which, when executed by processing circuitry (such as the processing circuitry 12, 22 of the entity 10, 20 described herein and/or the processing circuitry 32 of the wireless device 30 described herein), cause the processing circuitry to perform at least part of the method described herein. There is provided a computer program product, embodied on a non-transitory machine-readable medium, comprising instructions which are executable by processing circuitry (such as the processing circuitry 12, 22 of the entity 10, 20 described herein and/or the processing circuitry 32 of the wireless device 30 described herein) to cause the processing circuitry to perform at least part of the method described herein. There is provided a computer program product comprising a carrier containing instructions for causing processing circuitry (such as the processing circuitry 12, 22 of the entity 10, 20 described herein and/or the processing circuitry 32 of the wireless device 30 described herein) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the entity functionality, the node functionality, and/or the device functionality described herein can be performed by hardware. Thus, in some embodiments, the entity 10, 20, the master node 10, the node 20 that is separate from the master node 10, and/or the wireless device 30 described herein can be hardware. However, it will also be understood that optionally at least part or all of the entity functionality, node functionality, and/or device functionality described herein can be virtualized. For example, the functions performed by the entity 10, 20, the master node 10, the node 20 that is separate from the master node 10, and/or the wireless device 30 described herein can be implemented in software running on generic hardware that is configured to orchestrate them. Thus, in some embodiments, the entity 10, 20, the master node 10, the node 20 that is separate from the master node 10, and/or the wireless device 30 described herein can be virtual. In some embodiments, at least part or all of the entity functionality, node functionality, and/or device functionality described herein may be performed in a network enabled cloud. Thus, the method described herein can be realised as a cloud implementation according to some embodiments. The entity functionality, node functionality, and/or device functionality described herein may all be at the same location or at least some of the functionality may be distributed.

It will be understood that at least some or all of the method steps described herein can be automated in some embodiments. That is, in some embodiments, at least some or all of the method steps described herein can be performed automatically. The method described herein can be a computer-implemented method.

The techniques described herein include advantageous techniques for managing a cluster of worker nodes and, accordingly, controlling the operation of a wireless device. In particular, the advantageous techniques provide greater flexibility in provisioning computational resources in a network by enabling automation for wireless devices to join clusters dynamically. Moreover, the greater flexibility is provided in a simple, secure, and reliable manner, without the need for manual input.

The techniques described herein can be beneficial in a variety of use cases. For example, the techniques described herein can beneficially allow an owner of a cluster of worker nodes and/or a master node (e.g. a premises manager, such as an industrial premises manager) to easily define edge-cloud infrastructures, with minimal configuration and close to zero operational setup effort. In particular, the techniques described herein provide for wireless devices to join any cluster infrastructure from the same owner (e.g. any cluster that is registered to the same owner) as the wireless device and/or any cluster infrastructure that is controlled by a master node from the same owner (e.g. any master node that is registered to the same owner) as the wireless device. In doing so, the techniques described herein provide flexible computational clusters (e.g. within industrial premises or even outside of them, and/or within the same network slice). The techniques described herein can operate autonomously (e.g. requiring no manual configuration after an initial setup of a wireless device) and the cluster infrastructure can be immediately updated (e.g. whenever a wireless device shifts to a different location (e.g. premises) and/or network slice belonging to the same owner). There is only minimal configuration needed from the owner, and this is only during the initial configuration.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing a cluster of worker nodes that are controllable by a master node, the method being performed by an entity, the method comprising:
automatically allowing a wireless device to join the cluster as a worker node if the wireless device is authorised to join the cluster; and
the wireless device being authorised to join the cluster if the wireless device is registered to one or both of an owner of the master node and a cluster of worker nodes, the worker nodes being responsible for providing a computational resource in a network.

2. The method as claimed in claim 1, wherein:
the owner of the one or both of the master node and the cluster of worker nodes is:
a user of the one or both of the master node and the cluster of worker nodes;
a service provider of the one or both of the master node and the cluster of worker nodes; or
a manager of the one or both of the master node and the cluster of worker nodes.

3. The method as claimed in claim 2, wherein:
the owner of the one or both of the master node and the cluster of worker nodes is the manager of the one or both of the master node and the cluster of worker nodes; and
the wireless device is authorised to join the cluster if the wireless device is registered to the manager and a user of the wireless device is authorised by the manager to use the wireless device.

4. The method as claimed in claim 1, the method comprising:
automatically disallowing the wireless device from joining the cluster as a worker node if the wireless device is not authorised to join the cluster; and
wherein the wireless device is not authorised to join the cluster if the wireless device is not registered to an owner of the master node and the cluster of worker nodes.

5. The method as claimed in claim 1, the method comprising:
automatically allowing the wireless device to join the cluster when the wireless device moves into a geographical area served by the cluster or moves into a part of the network served by the cluster.

6. The method as claimed in claim 1, the method comprising:
determining if the wireless device is authorised to join the cluster.

7. The method as claimed in claim 1, wherein:
the wireless device is authorised to join the cluster if the wireless device has a public key that corresponds to a private key of the master node.

8. The method as claimed in claim 7, wherein one or both:
one or both of the public key and the private key are set by the owner of the one or both of the master node and the cluster of worker nodes; and
one or both of the public key and the private key are modifiable by the owner of the one or both of the master node and the cluster of worker nodes.

9. The method as claimed in claim 7, the method comprising:
acquiring the private key from a memory of the master node; and
acquiring the private key from a node that is separate from the master node and worker nodes.

10. The method as claimed in claim 9, wherein:
acquiring the private key from the node that is separate from the master node and worker nodes comprises:
initiating transmission of a request for the private key towards the node that is separate from the master node and worker nodes; and
receiving a response from the node that is separate from the master node and worker nodes, wherein the response comprises the private key.

11.-13. (canceled)

14. The method as claimed in claim 1, the method comprising:
automatically allowing the wireless device to leave the cluster when the wireless device moves outside a geographical area served by the cluster or moves outside a part of the network served by the cluster.

15.-32. (canceled)

33. An entity for managing a cluster of worker nodes that are controllable by a master node, the entity comprising:
processing circuitry configured to:
automatically allow a wireless device to join the cluster as a worker node if the wireless device is authorised to join the cluster; and
the wireless device being authorised to join the cluster if the wireless device is registered to one or both of an owner of the master node and a cluster of worker nodes, the worker nodes being responsible for providing a computational resource in a network.

34. (canceled)

35. A method for controlling the operation of a wireless device, the method being performed by the wireless device, the method comprising:
automatically joining a cluster of worker nodes as a worker node if an entity allows the wireless device to join the cluster of worker nodes, the cluster of worker nodes being controllable by a master node and the worker nodes are responsible for providing a computational resource in a network; and
the entity allowing the wireless device to join the cluster if the wireless device is authorised to join the cluster, the wireless device being authorised to join the cluster if the wireless device is registered to one or both of an owner of the master node and a cluster of worker nodes.

36. The method as claimed in claim 35, wherein:
the owner of the one or both of the master node and the cluster of worker nodes is:
a user of the one or both of the master node and the cluster of worker nodes;
a service provider of the one or both of the master node and the cluster of worker nodes; or
a manager of the one or both of the master node and the cluster of worker nodes.

37. The method as claimed in claim 36, wherein:
the owner of the master node and/or cluster of worker nodes is the manager of the one or both of the master node and the cluster of worker nodes; and
the wireless device is authorised to join the cluster if the wireless device is registered to the manager and a user of the wireless device is authorised by the manager to use the wireless device.

38. The method as claimed in claim 35, the method comprising:
automatically joining the cluster when the wireless device moves into a geographical area served by the cluster or moves into a part of the network served by the cluster.

39. The method as claimed in claim 35, wherein:
the wireless device is authorised to join the cluster if the wireless device has a public key that corresponds to a private key of the master node.

40. The method as claimed in claim 39, wherein one or both:
one or both of the public key and the private key are set by the owner of the one or both of the master node and the cluster of worker nodes; and
one or both of the public key and the private key are modifiable by the owner of the one or both of the master node and the cluster of worker nodes.

41. (canceled)

42. The method as claimed in claim 35, the method comprising:
initiating transmission of a request for the public key towards the entity; and
receiving the public key from the entity in response to the request.

43.-59. (canceled)

60. A wireless device, comprising:
processing circuitry configured to:
cause the wireless device to automatically joining a cluster of worker nodes as a worker node if an entity allows the wireless device to join the cluster of worker nodes, the cluster of worker nodes being controllable by a master node and the worker nodes are responsible for providing a computational resource in a network; and
the entity allowing the wireless device to join the cluster if the wireless device is authorised to join the cluster, the wireless device being authorised to join the cluster if the wireless device is registered to one or both of an owner of the master node and a cluster of worker nodes.

61.-65. (canceled)
